(19) United States
(12) Patent Application Publication
(10) Pub. No.: US 2026/0331985 A1
(43) Pub. Date: Oct. 22, 2026

(54) STATOR

(71) Applicant: AISIN CORPORATION, Kariya (JP)

(72) Inventors: So AKIMORI, Kariya-shi (JP); Yasunori OGURI, Kariya-shi (JP)

(73) Assignee: AISIN CORPORATION, Kariya (JP)

(21) Appl. No.: 19/468,578

(22) Filed: Feb. 3, 2026

(30) Foreign Application Priority Data
Feb. 13, 2025 (JP) 2025-021514

(51) Int. Cl. H02K 3/32; H02K 1/16; H02K 3/12; H02K 3/24; H02K 9/19

(52) U.S. Cl. CPC H02K 3/32; H02K 1/165; H02K 3/12; H02K 3/24; H02K 9/19

(57) ABSTRACT

A stator includes an annular stator core, a coil in a slot of the stator core, and an insulating member including a base material and surrounding the coil. An axial-direction flow passage is formed in the slot. At least a part in a portion in the insulating member not contacting with the axial-direction flow passage is configured as a double-sided foam portion. In a portion included in the insulating member and located in the axial-direction flow passage, the base material is exposed over an entire area of the base material in the axial direction, on at least a surface of the base material on a side of the axial-direction flow passage.

### CROSS REFERENCE TO RELATED APPLICATIONS

This application is based on and claims priority under 35 U.S.C. § 119 to Japanese Patent Application 2025-021514, filed on Feb. 13, 2025, the entire content of which is incorporated herein by reference.

### TECHNICAL FIELD

This disclosure generally relates to a stator.

### BACKGROUND DISCUSSION

A conventionally known stator includes a stator coil, an insulating member, and an annular stator core (e.g., refer to JP2024-125483A (Reference 1)). The stator coil is incorporated into the insulating member. A plurality of slots into which the stator coils are inserted are formed in the annular stator core. Reference 1 discloses that a foam layer is provided on a surface of the insulating member.

In the configuration where the foam layer is formed on the surface of the insulating member, there is a possibility that a refrigerant flowing through a flow passage in the slot causes the foam layer to be peeled off from the insulating member and the peeled foam layer clogs the flow passage.

A need thus exists for a stator, which is not susceptible to the drawback mentioned above.

### SUMMARY

A stator according to one embodiment includes an annular stator core, a coil, and an insulating member. The stator core includes a plurality of teeth being arranged in a circumferential direction and protruding in a radial direction, and a plurality of slots each formed between the teeth in the circumferential direction. The coil is arranged in the slot. The insulating member is provided in the slot in such a way as to surround the coil, and includes a sheet-shaped base material. An axial-direction flow passage for a refrigerant is formed in the slot in such a way as to penetrate between both ends of the slot in an axial direction of the stator core. At least a part in a portion that is included in the insulating member and that does not contact with the axial-direction flow passage is configured as a double-sided foam portion in which foam layers are provided on both surfaces of the base material. The foam layers fill a gap between one of the surfaces and the coil and a gap between another of the surfaces and a wall surface of the slot. In a portion being included in the insulating member and located in the axial-direction flow passage, the base material is exposed over an entire area of the base material in the axial direction, on at least a surface of the base material on a side of the axial-direction flow passage.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a plan view of a stator;

FIG. 2 is an enlarged view of a part A in FIG. 1, and is a plan view of a slot, an insulating member, and the like in a first embodiment;

FIG. 3 is a plan view of a slot central portion in the first embodiment;

FIG. 4A is a sectional view of the insulating member, and illustrates a double-sided foam portion in which foam layers are provided on both surfaces of a base material;

FIG. 4B is a sectional view of the insulating member, and illustrates a foam-layer-free portion in which no foam layer is provided on both surfaces of the base material;

FIG. 4C is a sectional view of the insulating member, and illustrates a single-sided foam portion in which a foam layer is provided on an outer surface of the base material and no foam layer is provided on an inner surface of the base material;

FIG. 5 is a sectional view at a line V-V in FIG. 2;

FIG. 6 is a plan view illustrating a slot, an insulating member, and the like in a second embodiment;

FIG. 7 is a sectional view at a line VII-VII in FIG. 6;

FIG. 8 is a plan view illustrating a slot, an insulating member, and the like in a third embodiment;

FIG. 9 is a sectional view at a line IX-IX in FIG. 8;

FIG. 10 is a plan view illustrating a slot, an insulating member, and the like in a fourth embodiment;

FIG. 11 is a sectional view at a line XI-XI in FIG. 10;

FIG. 12 is a plan view illustrating a slot, an insulating member, and the like in a fifth embodiment;

FIG. 13 is a sectional view at a line XIII-XIII in FIG. 12;

FIG. 14 is a plan view illustrating a slot, an insulating member, and the like in a sixth embodiment; and

FIG. 15 is a sectional view at a line XV-XV in FIG. 14.

### DETAILED DESCRIPTION

Embodiments of this disclosure are described below in the following order.
(1) First Embodiment:
(2) Second Embodiment:
(3) Third Embodiment:
(4) Fourth Embodiment:
(5) Fifth Embodiment:
(6) Sixth Embodiment:
(7) Other Embodiments:

### First Embodiment

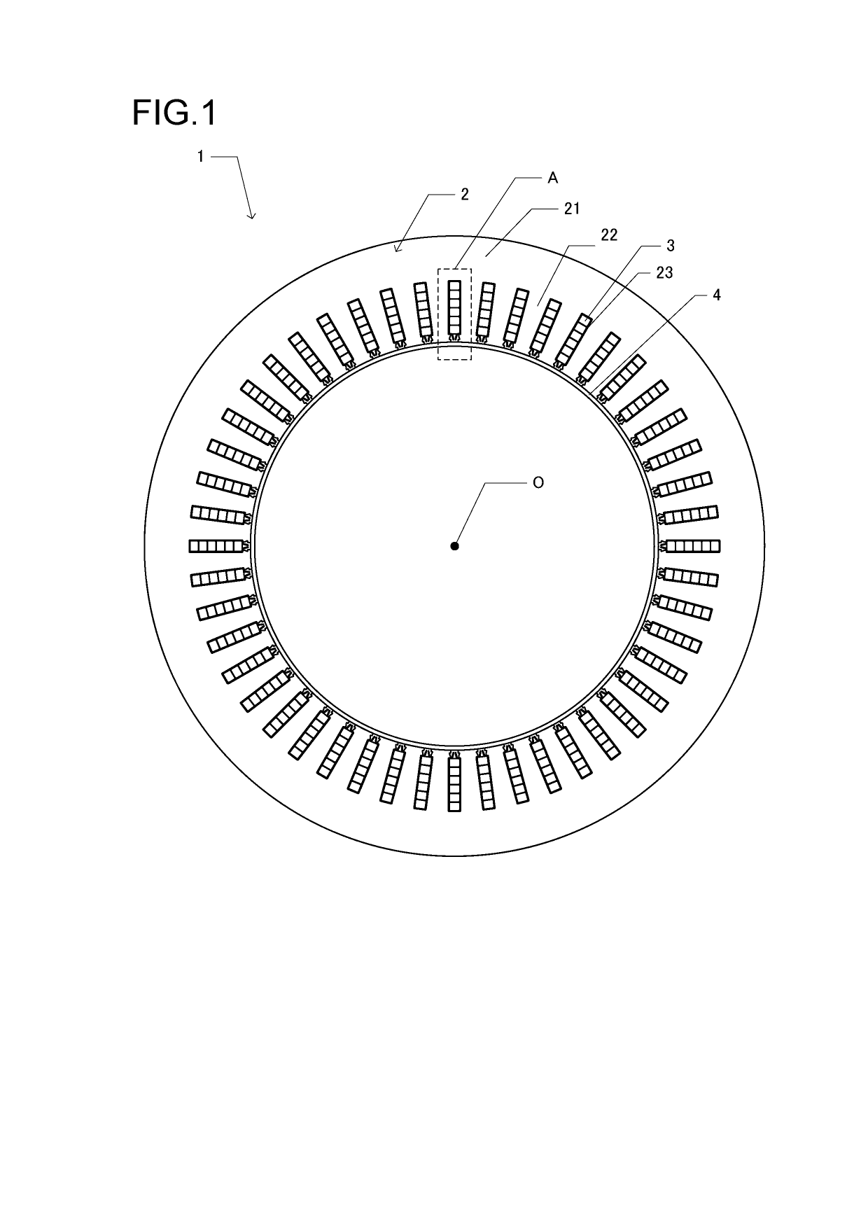

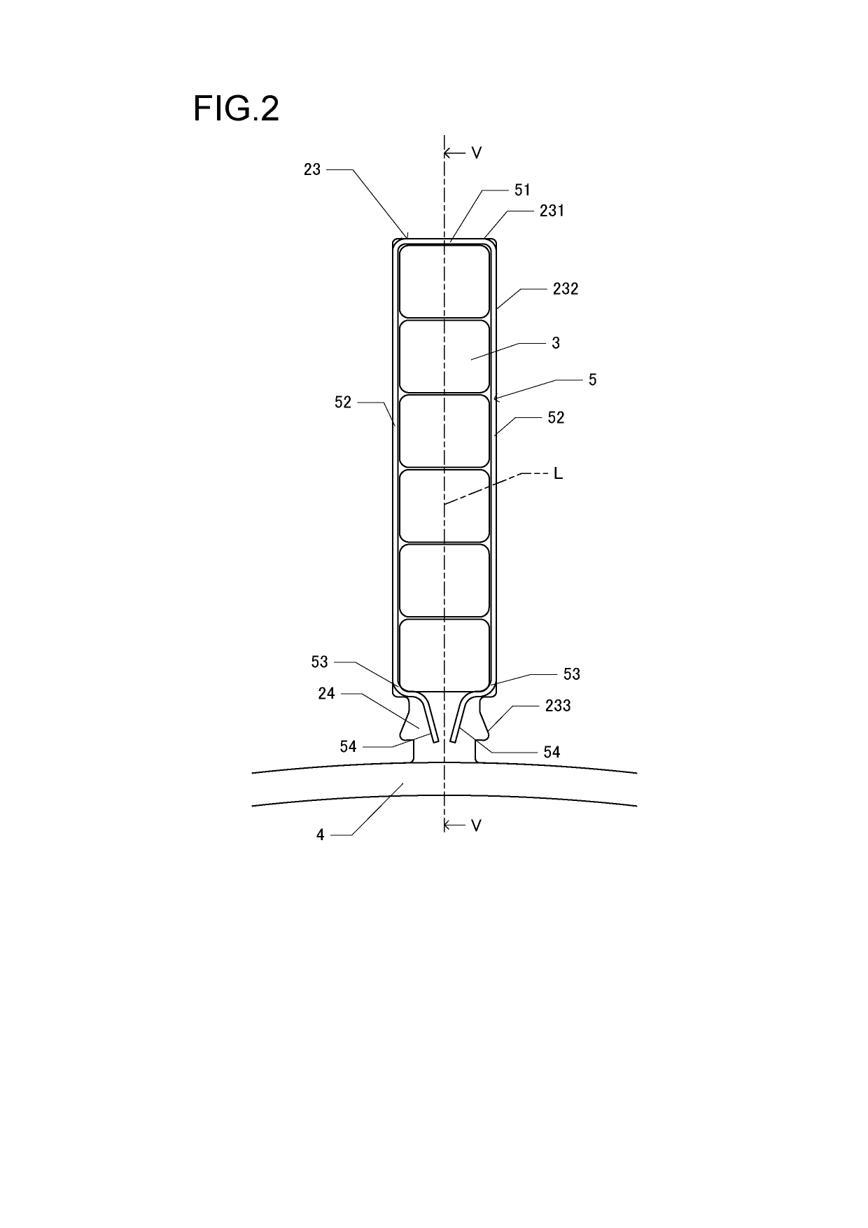

FIG. 1 is a plan view of a stator 1 according to this embodiment. FIG. 2 is an enlarged view of a part A in FIG. 1. Hereinafter, an axial direction denotes a direction parallel to the central axis that is a straight line perpendicular to the sheet surface of FIG. 1 and passing through the center O of the below-described stator core 2. A circumferential direction denotes a direction along circumference of a circle around the central axis. A radial direction denotes a direction parallel to a radius of the circle. Further, a radial-direction inner side denotes a side closer to the central axis in the radial direction. A radial-direction outer side denotes a side more distant from the central axis in the radial direction. FIG. 1 depicts the stator 1 viewed in the axial direction, and illustrates a state where coil end portions are cut in a direction perpendicular to the axial direction. The coil end portions are portions that are included in the coils 3 and that are not accommodated in the stator core 2.

The stator 1 is a stator of a rotating electric machine. The rotating electric machine to which the stator 1 is applied is a synchronous motor, for example. The rotating electric machine to which the stator 1 is applied is an inner-rotor type. In other words, the rotating electric machine includes the stator 1 and an unillustrated rotor that is provided on an inner side of the stator 1. The stator 1 is a member for forming magnetic poles at the below-described teeth 22 and forming a rotating magnetic field in such a way that polarities (a north pole and a south pole) of the magnetic poles change over time. The rotor is arranged in such a way as to be rotatable around the above-mentioned central axis. The rotor forms magnetic poles at an outer circumference of the rotor. The rotor rotates by the interaction between the magnetic poles of the rotor and the magnetic poles of the stator 1. The stator 1 and the rotor are accommodated in an unillustrated case.

The stator 1 includes the stator core 2, the coils 3, an inner circumferential cover 4, and an insulating member 5. The stator core 2 is an annular member. The stator core 2 is a laminated body constituted by a plurality of electromagnetic steel sheets (e.g., silicon steel sheets) stacked over each other in the axial direction. The steel sheets are each formed into a substantially annular shape by press working, for example. Alternatively, the stator core 2 may be a pressed-powder magnetic core formed by press molding of magnetic particles. The stator core 2 includes an annular core body 21, a plurality of the teeth 22 aligned in the circumferential direction and protruding to a radial-direction inner side from an inner circumferential surface of the core body 21, and a plurality of slots 23 formed between the teeth 22 in the circumferential direction.

The teeth 22 are formed at constant intervals in the circumferential direction over the entire circumference of the inner surface of the core body 21. The number of the teeth 22 may be any of various numbers. In this embodiment, the sectional shape of the teeth 22 cut in a direction perpendicular to the axial direction is the same at any position in the axial direction. Accordingly, the teeth 22 are portions that protrude to a radial-direction inner side and that extend in the axial direction while maintaining the same sectional shape cut in the direction perpendicular to the axial direction. The respective tooth 22 have the mutually same shape.

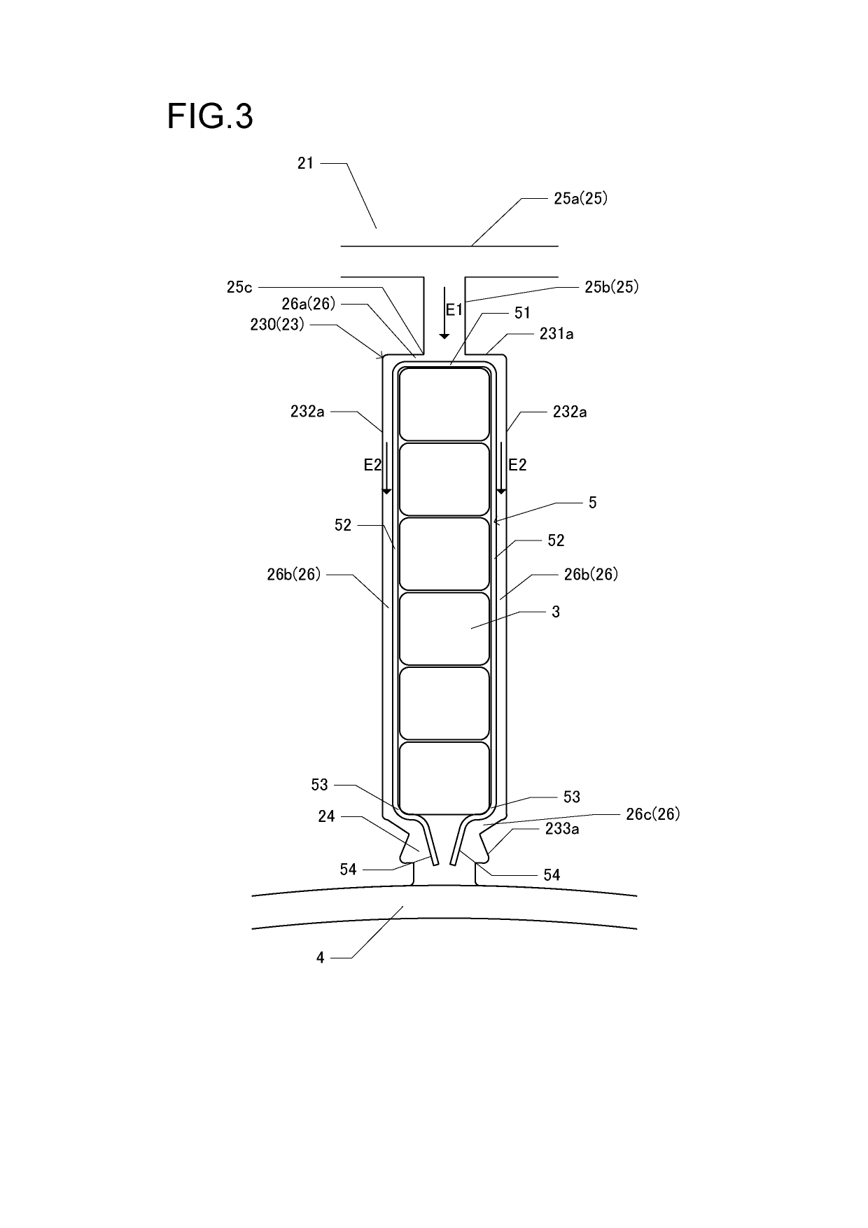

The slots 23 are spaces formed between the teeth 22 in the circumferential direction and provided for accommodating the coils 3. The slots 23 penetrate through the stator core 2 in the axial direction. The slots 23 each form an opening on a radial-direction inner side. The sectional shape of each of the slots 23 cut in the direction perpendicular to the axial direction is the same at any position in the axial direction, except for a shape (refer to FIG. 3) at a central position of the slot 23 in the axial direction. The central position refers to the position dividing each of the slots 23 into two equal portions along the axial direction. FIG. 2 illustrates the slot 23 and the like at the axial-direction position other than the central position, viewed in the axial direction. The respective slots 23 have the mutually same shape.

As illustrated in FIG. 2, when viewed in the axial direction, the slot 23 includes a bottom surface 231 that forms a part of the inner circumferential surface of the core body 21, two side surfaces 232 that extend in the radial direction from end portions of the bottom surface 231, and two extension surfaces 233 that extend to a radial-direction inner side from the side surfaces 232. The bottom surface 231 is a surface included in a wall surface of the slot 23 and located on a radial-direction outer side. When viewed in the axial direction, the bottom surface 231 forms a straight line perpendicular to the radial direction. When viewed in the axial direction, the side surfaces 232 each form a straight line extending parallel to the radial direction. The side surfaces 232 each constitute a part of a side surface of the tooth 22. The two side surfaces 232 are provided parallel to each other. A space surrounded by the bottom surface 231 and the two side surfaces 232 is an accommodation space for the coil 3.

The extension surfaces 233 are located on a radial-direction inner side of the coil 3 accommodated in the slot 23. The extension surfaces 233 each constitute a distal-end side portion of the side surface of the tooth 22. The extension surfaces 233 each include a surface that is non-parallel to the radial direction. A width between the two extension surfaces 233 is smaller than a width between the two side surfaces 232, i.e., a width of the space accommodating the coil 3. Thereby, the coil 3 is prevented from slipping out of the slot 23. The extension surfaces 233 are surfaces of a flow passage for a refrigerant. In other words, a space 24 sandwiched between the two extension surfaces 233 is the flow passage for the refrigerant. The flow passage 24 penetrates through the stator core 2 in the axial direction. In other words, the flow passage 24 is an axial-direction flow passage that extends in the axial direction between both ends of the slot 23 in such a way as to penetrate in the axial direction. The axial-direction flow passage 24 is located on a radial-direction inner side of the coil 3.

FIG. 3 illustrates a section of a portion 230 included in the slot 23 and located at the central position in the axial direction. The section in FIG. 3 is a section perpendicular to the axial direction. Hereinafter, the portion 230 is referred to as a slot central portion in some cases. The slot central portion 230 is formed to have a larger outline than the portion included in the slot 23 and located at each position other than the central position. Specifically, the slot central portion 230 includes a bottom surface 231a that constitutes a part of the inner circumferential surface of the core body 21, two side surfaces 232a that extend in the radial direction from end portions of the bottom surface 231a, and two extension surfaces 233a that extend to a radial-direction inner side from the side surfaces 232a. A gap 26 is formed between the below-described insulating member 5 and each of these surfaces 231a, 232a, and 233a. The refrigerant can flow through the gap 26 in a direction perpendicular to the axial direction. The gap 26 includes a gap 26a formed between the bottom surface 231a and a portion 51 included in the insulating member 5 and facing the bottom surface 231a, a gap 26b formed between each of the side surfaces 232a and a portion 52 included in the insulating member 5 and facing the side surface 232a, and a gap 26c connecting the axial-direction flow passage 24 and each of the gaps 26b to each other.

The bottom surface 231a is located in such a way as to be shifted, by a radial-direction width of the gap 26a, to a radial-direction outer side from the bottom surface 231 (refer to FIG. 2) at each of the axial-direction positions other than the central position. An opening 25c is formed on the bottom surface 231a. The opening 25c serves as an inlet through which the refrigerant flows into the slot central portion 230. A width between the two side surfaces 232a is larger than a width between the two side surfaces 232 in FIG. 2. Hereinafter, the gap 26 is referred to as a central flow passage in some cases.

The core body 21 includes a flow passage 25 that supplies the refrigerant to the central flow passage 26. For example, the flow passage 25 includes a circumferential flow passage 25a extending in the circumferential direction, and a radial-direction flow passage 25b extending in the radial direction from the circumferential flow passage 25a. The circumferential flow passage 25a may be formed in such a way as to extend over the entire circumference at the axial-direction central position in the core body 21. Alternatively, the circumferential flow passage 25a may be divided into a plurality of passages in the circumferential direction. A plurality of the radial-direction flow passages 25b toward the slot central portions 230 of the respective slots 23 may each extend from the circumferential flow passage 25a. Radial-direction inner end portions of the radial-direction flow passages 25b are each the opening 25c formed on the bottom surface 231a.

A plurality of the coils 3 are arranged in the radial direction in the space that is formed in the slot 23 in such a way as to be surrounded by the bottom surfaces 231 and 231a and the side surfaces 232 and 232a. The number of the coils 3 arranged in the radial direction is not particularly limited, but is six in this embodiment. The coils 3 each include accommodated portions arranged in the slots 23 and coil end portions protruding in the axial direction from end surfaces of the stator core 2. The accommodated portions of each coil 3 extend linearly in the axial direction. In this embodiment, each coil 3 is a quadrilateral wire having a quadrilateral cross section. However, each coil 3 may also be a round wire having a circular cross section. Each coil 3 is connected to one phase of a three-phase alternating current, for example. Thereby, each coil 3 generates a magnetic pole at each tooth 22 whose polarity changes over time.

The inner circumferential cover 4 is a cylindrical member, and has an axial-direction length that is substantially the same as an axial-direction length of the stator core 2. A diameter of an outer circumferential surface on a radial-direction outer side in the inner circumferential cover 4 is substantially the same as a diameter of an inner circumferential surface of the stator core 2 on a radial-direction inner side. The inner circumferential cover 4 is used in such a way as to be fitted into a radial-direction inner side of the stator core 2. The inner circumferential cover 4 is the plate-shaped member, and extends over an entire inner circumference of the stator core 2, and thereby closes the openings on a radial-direction inner-side in the slots 23. As a result, the refrigerant flowing through the axial-direction flow passages 24 is prevented from leaking to a radial-direction inner side.

The insulating member 5 illustrated in FIG. 2 and FIG. 3 is provided for each slot 23 in such a way as to surround the accommodated portion of the coils 3 in the slot 23. The insulating member 5 is arranged in such a way as to extend between outer peripheral surface of the coils 3 and each of the bottom surfaces 231 and 231a and the side surfaces 232 and 232a of the slot 23. The insulating member 5 is arranged in such a way as to collectively surround all of the coils 3 arranged in one slot 23. The insulating member 5 is a sheet-shaped member bent to follow a shape of the slot 23 and an outer shape of the coils 3. For example, the insulating member 5 has a length equal to an entire length of the slot 23 in the axial direction. However, the insulating member 5 may be formed longer than the entire length of the slot 23.

The insulating member 5 includes an outer peripheral portion 51, two side portions 52, two corner portions 53, and two non-contact portions 54. The outer peripheral portion 51 is a portion located on a radial-direction outer side of the coils 3. The outer peripheral portion 51 is a portion facing the bottom surfaces 231 and 231a of the slot 23 and a radial-direction outer surface of the coil 3. The outer peripheral portion 51 in the slot central portion 230 faces the opening 25c formed on the bottom surface 231a. When viewed in the axial direction, the outer peripheral portion 51 extends linearly in a direction perpendicular to the radial direction. The side portions 52 are portions that face the side surfaces 232 and 232a of the slot 23 and side surfaces of the coils 3. When viewed in the axial direction, the side portions 52 extend linearly to a radial-direction inner side from end portions of the outer peripheral portion 51. One of the two side portions 52 extends to a radial-direction inner side from the one end portion of the outer peripheral portion 51, and faces the side surfaces 232 and 232a on one side. The other side portion 52 extends to a radial-direction inner side from the other end portion of the outer peripheral portion 51, and faces the side surfaces 232 and 232a on the other side.

The corner portions 53 are connected to the radial-direction inner end portions of the side portions 52, and are bent from the side portions 52 to follow shapes of the coil 3 and the slot 23. The corner portions 53 are each a portion between the side portion 52 and the non-contact portion 54. In other words, the corner portions 53 are each a bent portion included in the insulating member 5 and located at a boundary between the portion 54 contacting with the axial-direction flow passage 24 and the portion 52 in non-contact with the axial-direction flow passage 24, in the insulating member 5. The one corner portion 53 is connected to the one side portion 52. The other corner portion 53 is connected to the other side portion 52. The outer peripheral portion 51, the side portions 52, and the corner portions 53 contact with the outer peripheral surface of the coils 3.

The non-contact portions 54 are each a part that is included in an end portion of the insulating member 5 when viewed in the axial direction, and that does not contact with any of the coils 3. In other words, the non-contact portions 54 are each a portion that extends to a radial-direction inner side to a position beyond a radial-direction inner surface of the coil 3. The non-contact portions 54 are each located on a radial-direction inner side of the coils 3. One of the two non-contact portions 54 constitutes a portion included in the one end portion of the insulating member 5 when viewed in the axial direction. The other non-contact portion 54 constitutes a portion included in the other end portion of the insulating member 5 when viewed in the axial direction. Each non-contact portion 54 extends to a radial-direction inner side from the corresponding corner portion 53 as the non-contact portion 54 extends toward the central line L (refer to FIG. 2) of the slot 23. The central line L is a straight line extending in the radial direction and passing through a middle position between the two side surfaces 232. A gap is provided between an end portion included in the one non-contact portion 54 and opposite to a side where the one non-contact portion 54 is connected to the corner portion 53 and a corresponding end portion of the other non-contact portion 54. In other words, a pair of the non-contact portions 54 do not overlap with each other. The non-contact portions 54 contact with the axial-direction flow passage 24. In other words, the non-contact portions 54 are located in the axial-direction flow passage 24.

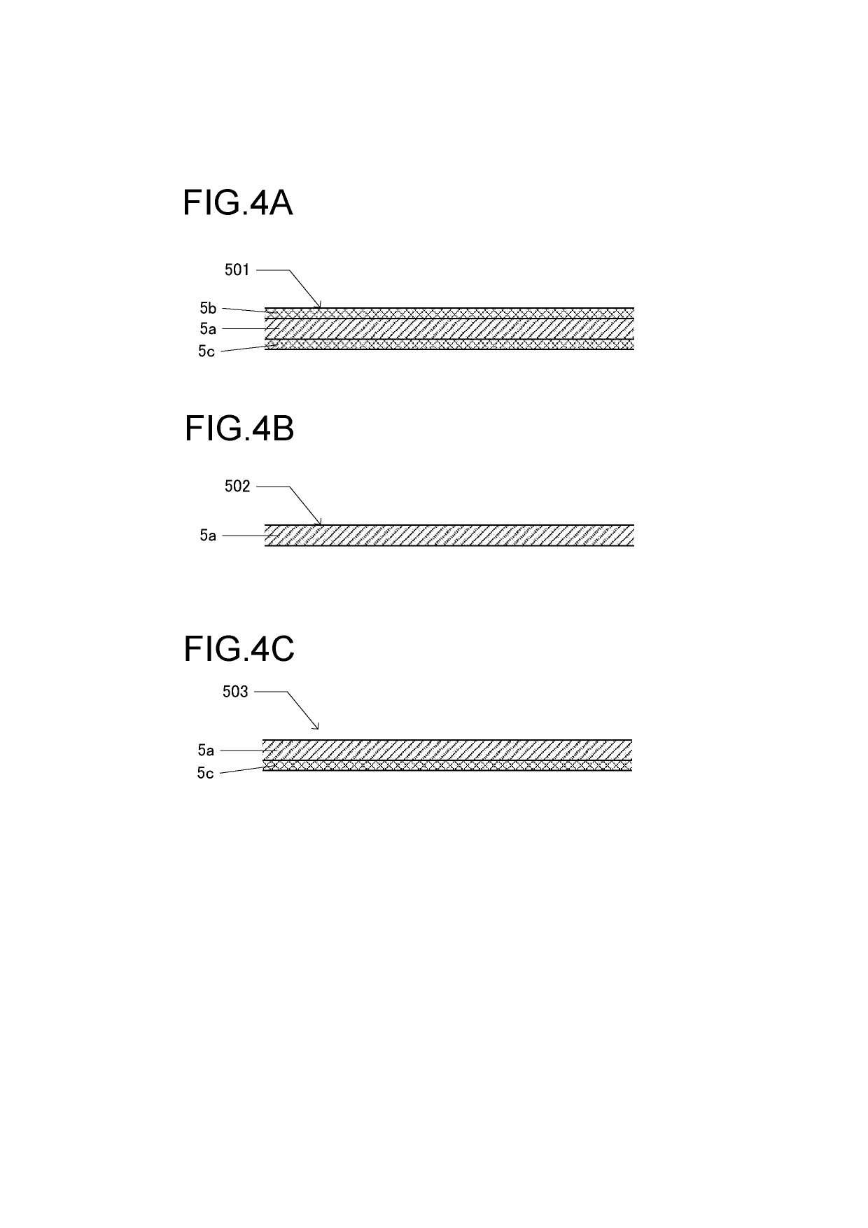

As illustrated in FIG. 4A and FIG. 4B, the insulating member 5 includes a sheet-shaped base material 5a. The base material 5a is a resin sheet formed of an insulating resin material such as polyphenylene sulfide or polyethylene naphthalate. The base material 5a may be constituted by a plurality of layers superimposed on each other. For example, the base material 5a may be constituted by a fiber layer and the above-described resin sheet superimposed on each other. The fiber layer is formed of aramid fiber or the like. The insulating member 5 is configured to include a double-sided foam portion 501 (refer to FIG. 4A) and a foam-layer-free portion 502 (refer to FIG. 4B). The double-sided foam portion 501 includes the base material 5a and foam layers 5b and 5c provided on both surfaces of the base material 5a. The foam-layer-free portion 502 includes the base material 5a without a foam layer on either surface of the base material 5a. The foam-layer-free portion 502 is a portion where the base material 5a is exposed. The foam-layer-free portion 502 is thinner than the double-sided foam portion 501 by the absent foam layers. A configuration of FIG. 4C is described in the section of (7) Other Embodiments.

The double-sided foam portion 501 includes the foam layer 5b provided on the outer surface that is included in the base material 5a and that is located on a side of the wall surface of the slot 23, and the foam layer 5c provided on the inner surface that is included in the base material 5a and that is located on a side of the coils 3. The foam layers 5b and 5c are each formed of a foaming agent, for example. When heated, the foaming agent foams and expands, and becomes adhesive. The foaming agents that form the foam layers 5b and 5c are each configured to include a base material made of an epoxy-based resin material for example and acrylic capsules including liquid isopentane inside and dispersed in the base material. Thus, when the foaming agent is heated, the liquid isopentane inside the capsules vaporizes and expands, and thereby causes the base material to be foamed.

In this embodiment, the double-sided foam portion 501 is constituted by the outer peripheral portion 51 and the two side portions 52 in FIG. 2 that are arranged at axial-direction positions other than the slot central portion 230 in FIG. 3. In other words, the outer peripheral portion 51 and the two side portions 52 in FIG. 2 each include the base material 5a, the foam layer 5b provided on the outer surface of the base material 5a, and the foam layer 5c provided on the inner surface of the base material 5a. The foam layer 5b fills a gap between the outer surface of the base material 5a and each of the bottom surface 231 and the two side surfaces 232 of the slot 23. The foam layer 5c fills a gap between the inner surface of the base material 5a and the outer peripheral surfaces of the coils 3. Thus, the foam layers 5b and 5c cause the outer peripheral portion 51 to be closely contacted with and adhered to the bottom surface 231 and the coil 3. The foam layers 5b and 5c cause the side portions 52 to be closely contacted with and adhered to the side surfaces 232 and the coils 3.

More specifically, at each position that are among positions along the axial direction and at which any refrigerant flow passage other than the axial-direction flow passage 24 does not exist in the slot 23, i.e., at each position other than the axial-direction central position, the outer peripheral portion 51 and the side portions 52 in FIG. 2 are each configured as the double-sided foam portion 501 over an entire area along the outer periphery of the coils 3 when viewed in the axial direction, except for the corner portions 53. The side surfaces and the radial-direction outer surface of the coils 3 are fixed to the wall surfaces 231 and 232 defining the slot 23 and facing the side surfaces and the radial-direction outer surface of the coils 3, by the foam layers 5b and 5c of the outer peripheral portion 51 and the side portions 52, over the entire area along the outer periphery of the coils 3, except for portions included in the coil 3 and contacting with the corner portions 53, when viewed in the axial direction. In order to facilitate understanding of a positional relation between the members, the illustration of FIG. 2 is made in such a way that a gap appears to be formed between each of the outer peripheral portion 51 and the side portions 52 and the corresponding one or more coils 3 and between each of the outer peripheral portion 51 and the side portions 52 and the corresponding wall surface 231 or 232. However, these gaps are actually filled with the foam the layers 5b and 5c. Further, in this embodiment, the outer peripheral portion 51 and the side portions 52 are each configured as the double-sided foam portion 501 over the entire axial-direction area except for the axial-direction central position.

Meanwhile, the two non-contact portions 54 in FIG. 2 are each configured as the foam-layer-free portion 502, and the respective portions 51 to 54 of the insulating member 5 in the slot central portion 230 in FIG. 3 are each configured as the foam-layer-free portion 502. The non-contact portions 54 are each configured as the foam-layer-free portion 502 over the entire axial-direction area. The two corner portions 53 in FIG. 2 may be each configured as the double-sided foam portion 501 or as the foam-layer-free portion 502.

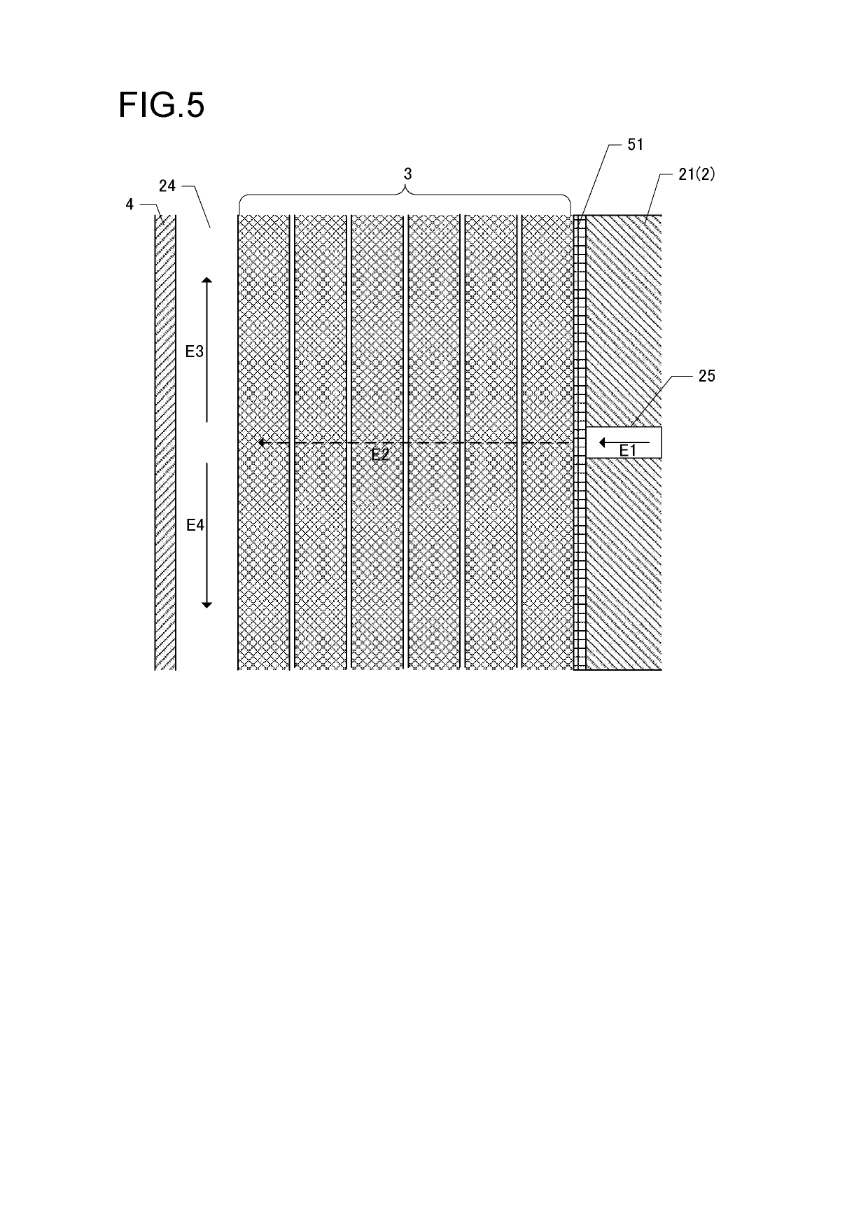

Next, the flowing of the refrigerant in this embodiment is described with reference to FIGS. 3 and 5. FIG. 5 is a sectional view at the line V-V in FIG. 2. FIGS. 3 and 5 indicate the flows of the refrigerant by the arrows E1 to E4. The flow E1 indicates the flow of the refrigerant in the flow passage 25 of the core body 21. The flow E2 indicates the flow of the refrigerant in the central flow passage 26 formed in the slot central portion 230. The flows E3 and E4 indicate the flows of the refrigerant in the axial-direction flow passage 24. The refrigerant is oil such as lubricating oil or hydraulic oil, for example, but may also be other liquid or gas. The refrigerant sent out by an unillustrated pump is cooled by an unillustrated heat exchanger and then supplied to the flow passage 25 in the core body 21. The refrigerant that has been supplied to the flow passage 25 flows into the central flow passage 26 of each slot central portion 230. The refrigerant that has flowed into the central passage 26 first flows through the gap 26a between the bottom surface 231a and the coil 3, and then flows to a radial-direction inner side through the gap 26b between each side surface 232a and the coils 3. After that, the refrigerant passes through each gap 26c, and then flows into the axial-direction passage 24. The refrigerant that has flowed into the axial-direction passage 24 is divided into the flow E3 flowing to one side in the axial direction and the flow E4 flowing to an opposite side in the axial direction, and thus flows in the axial-direction passage 24 in the axial direction. Then, the refrigerant flows out of the stator core 2 from openings at both axial-direction ends of the axial-direction passage 24. The refrigerant that has flowed out flows through an unillustrated external passage, and then returns to the pump.

The following describes advantageous effects of this embodiment. According to this embodiment, the axial-direction passage 24 is provided in each slot 23 in such a way as to extend over an entire axial-direction length of the slot 23. The refrigerant flows through each of these axial-direction passages 24. Thereby, the coils 3 arranged in the slots 23 and the stator core 2 can be cooled over a wide axial-direction range. Thus, the stator 1 can be efficiently cooled. The coil 3 located on a radial-direction inner side among a plurality of the coils 3 arranged in each slot 23 tends to generate the most heat. In this regard, in this embodiment, the axial-direction flow passage 24 is located on a radial-direction inner side of the coils 3. For this reason, the coil 3 located on a radial-direction inner side can be efficiently cooled. Since any axial-direction flow passages is not provided between the coils 3 and each of the side surfaces 232 of each slot 23, a circumferential-direction width of the slot 23 can be reduced.

Since the coils 3 are surrounded by the insulating member 5 in the slot 23, the coils 3 can be insulated from the stator core 2. The non-contact portions 54 that are included in the insulating member 5 and that do not contact with any of the coils 3 contact with the axial-direction flow passage 24. The non-contact portions 54 are each the foam-layer-free portion 502 that does not include a foam layer on either surface of the base material 5a. For this reason, peeling of the foam layer from the insulating member 5 due to the refrigerant flowing through the axial-direction flow passage 24 can be suppressed, and clogging of the axial-direction flow passage 24 due to the foam layer can be thus suppressed. Since the foam-layer-free portion 502 is thinner than the double-sided foam portion 501, narrowing of the axial-direction flow passage 24 can be suppressed. Thereby, the coils 3 and the stator core 2 can be efficiently cooled. Further, the non-contact portions 54 each have no foam layer over the entire axial-direction area so that peeling of the foam layer from the insulating member 5 can be more suppressed, and the axial-direction flow passage 24 can be widened over an axial-direction wide range. Furthermore, a gap is formed between distal ends of the two non-contact portions 54. Accordingly, the refrigerant is allowed to directly contact with the coil through this gap. Thereby, the coil 3 can be more efficiently cooled.

At each position other than the axial-direction central position, the outer peripheral portion 51 and the side portions 52 of the insulating member 5 are each the double-sided foam portion 501 including the foam layers 5b and 5c on both surfaces of the base material 5a over the entire area along the outer periphery of the coils 3 when viewed in the axial direction. Thereby, the coils 3 can be effectively fixed via the double-sided foam portion 501 in the slot 23. In other words, both side surfaces of the coils 3 facing the side surfaces 232 of the slot 23, and the radial-direction outer surface of the coil 3 facing the bottom surface 231 of the slot 23 can be fixed to the wall surfaces 232 and 231 of the slot 23 by the foam layers 5b and 5c over the entire area along the outer periphery of the coils 3 when viewed in the axial direction. Thereby, movement of the coil 3 in the slot 23 can be suppressed even without the foam layers 5b and 5c provided over the entire axial-direction area, and the axial-direction flow passage 24 can be easily formed in the slot 23. Providing the insulating member 5 can more effectively insulate the coils 3 from the stator core 2 than a case without the provision of the insulating member 5. Further, the outer peripheral portion 51 and the side portions 52 are configured as the double-sided foam portions 501 over the entire axial-direction area except for the axial-direction central position. Thereby, the coils 3 can be more effectively fixed in the slot 23.

The portions 51 to 53 included in the insulating member 5 and contacting with the central flow passage 26 (refer to FIG. 3) are configured as foam-layer-free portions 502. Thereby, peeling of the foam layers of the insulating member 5 due to the refrigerant flowing through the central flow passage 26 can be suppressed, and narrowing of the central flow passage 26 due to the foam layers can be suppressed. Accordingly, the coils 3 and the stator core 2 can be efficiently cooled.

### Second Embodiment

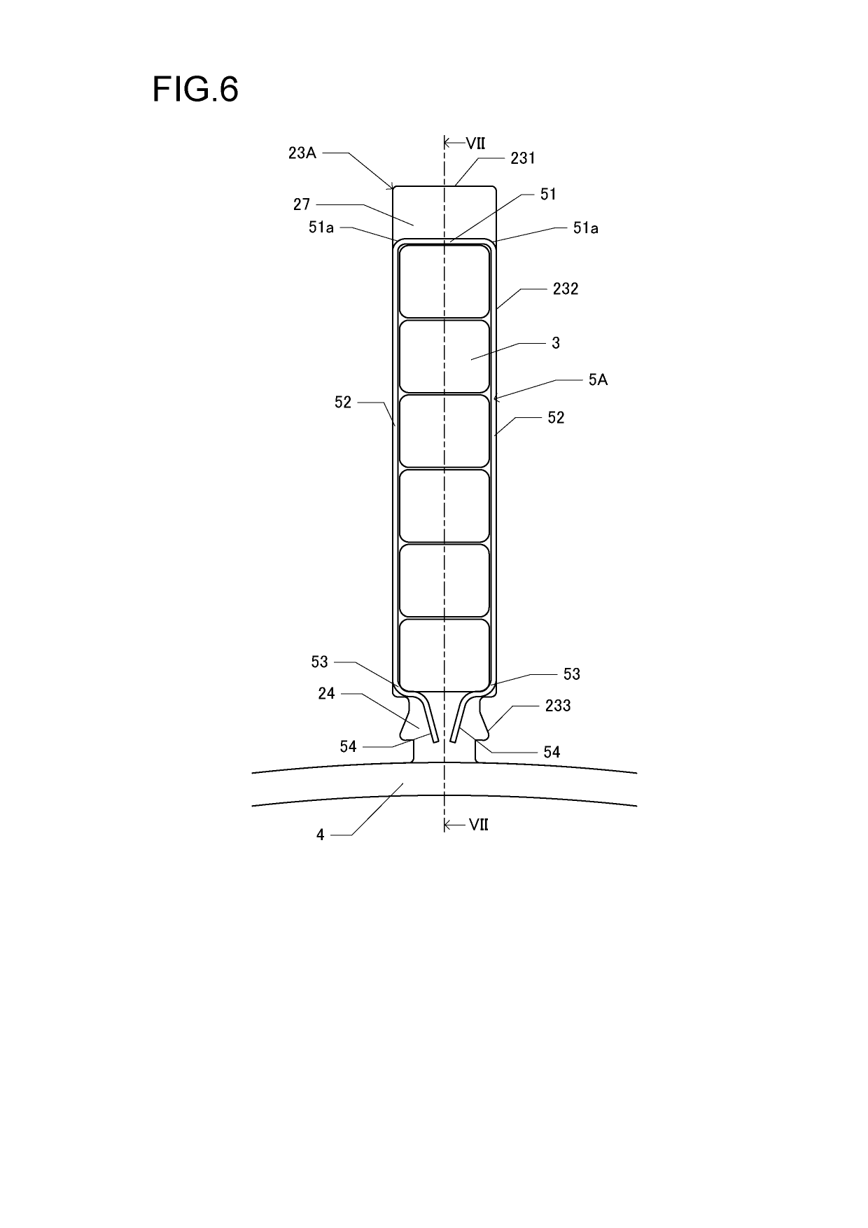

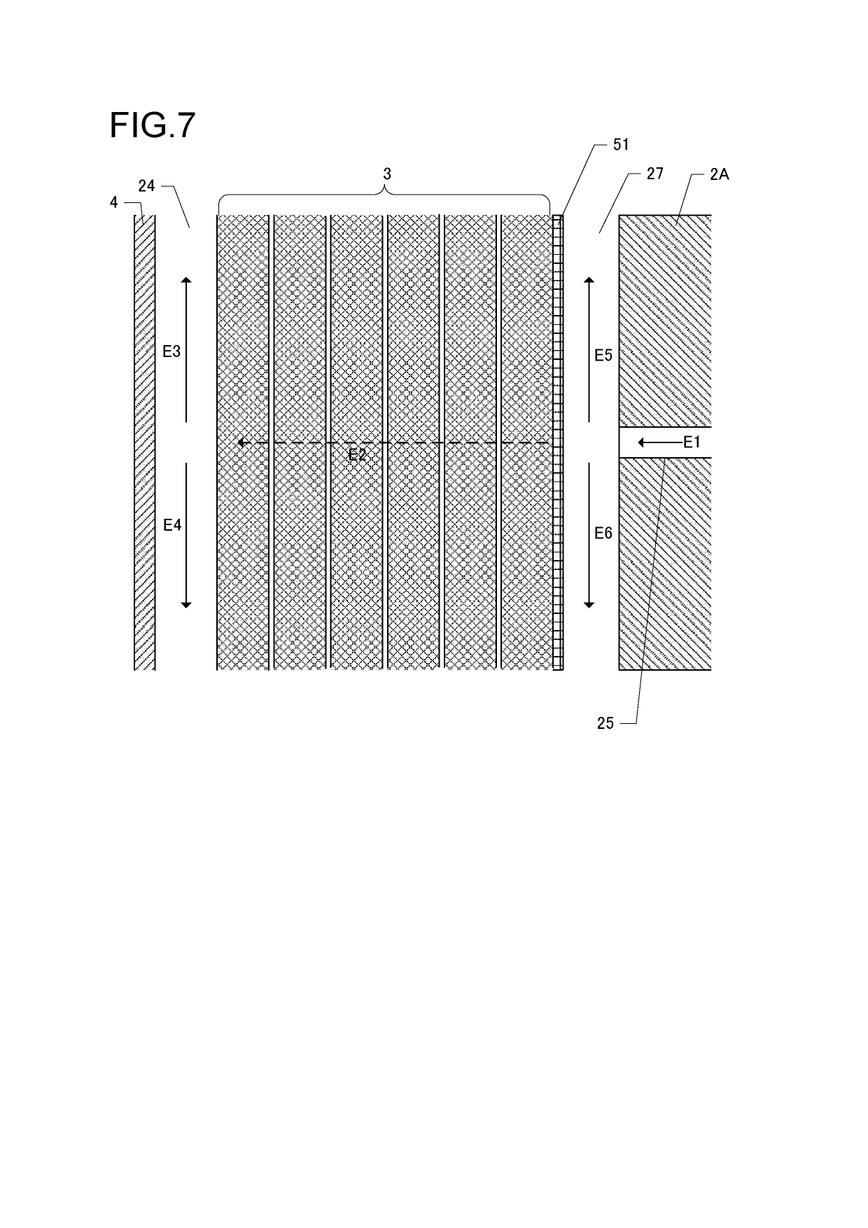

Next, a second embodiment of this disclosure is described mainly concerning matters different from the first embodiment. FIG. 6 illustrates a slot 23A, an insulating member 5A, and the like in this embodiment viewed in the axial direction. FIG. 6 depicts a shape of the slot 23A at each position other than the axial-direction central position. FIG. 7 is a sectional view at the line VII-VII in FIG. 6. In FIG. 6 and FIG. 7, constituents equivalent to those in the first embodiment are denoted by the same reference signs in the first embodiment. The description of these constituents is omitted as appropriate.

The slot 23A includes an axial-direction flow passage 27 that penetrates between both axial-direction ends of the slot 23A and that is located between the bottom surface 231 and the outer peripheral portion 51 of the insulating member 5. In other words, the axial-direction flow passage 27 penetrates through the stator core 2A (refer to FIG. 7) in the axial direction. The axial-direction flow passage 27 is located on a radial-direction outer side of the coils 3. The slot 23A differs from the slot 23 of the first embodiment in including the axial-direction flow passage 27. The other matters of the slot 23A are equivalent to those of the slot 23, and thus, the description of these matters are omitted. The stator core 2A differs from the stator core 2 of the first embodiment in including the slot 23A provided with the axial-direction flow passage 27. The other matters of the stator core 2A are equivalent to those of the stator core 2.

The coils 3 and the inner circumferential cover 4 are equivalent to the coils 3 and the inner circumferential cover 4 in the first embodiment. The outer peripheral portion 51 of the insulating member 5A contacts with the axial-direction flow passage 27 over an entire axial-direction area of the outer peripheral portion 51. The outer peripheral portion 51 (excluding corner portions 51a) is configured as the foam-layer-free portion 502 illustrated in FIG. 4B. The corner portions 51a of the outer peripheral portion 51 may be each configured as the foam-layer-free portion 502 or as the double-sided foam portion 501. The side portions 52 excluding the corner portions 51a and 53 are each configured as the double-sided foam portion 501 over an entire area along the outer periphery of the coils 3 when viewed in the axial direction. Except for portions that are included in the coils 3 and that contact with the corner portions 51a and 53, the side surfaces of the coils 3 are fixed to the wall surfaces 232 of the slots 23 facing these side surfaces, by the foam layers 5b and 5c of the side portions 52, over an entire area along the outer periphery of the coil 3, when viewed in the axial direction. Further, the side portions 52 are each configured as the double-sided foam portion 501 along the entire axial-direction area except for the axial-direction central position. The other matters of the insulating member 5A are equivalent to those of the insulating member 5 in the first embodiment.

Next, the flowing of the refrigerant in this embodiment is described with reference to FIG. 7. FIG. 7 indicates the flows of the refrigerant by the arrows E1 to E6. The flows E1 to E4 are equivalent to the flows E1 to E4 (refer to FIGS. 3 and 5) in the first embodiment. The flows E5 and E6 indicate the flows of the refrigerant in the axial-direction flow passage 27. The refrigerant sent out by the unillustrated pump is cooled by the unillustrated heat exchanger and then supplied to the flow passage 25 in the stator core 2A. The refrigerant that has been supplied to the flow passage 25 flows into each slot central portion. The refrigerant that has flowed into the slot central portion turns into an axial-direction flow in the axial-direction flow passage 27, in addition to the flows E1 to E4 equivalent to those in the first embodiment. In other words, the refrigerant is divided from the flow at the axial-direction central position into the flow E5 flowing to one side in the axial direction and the flow E6 flowing to the other side in the axial direction. Then, the refrigerant flows out of the stator core 2A from openings at both axial-direction ends of the axial-direction flow passage 27. The refrigerant that has flowed out flows through an unillustrated external flow passage, and then returns to the pump.

In this embodiment, the refrigerant flows in the axial-direction flow passage 27 in the axial-direction. Thereby, the coils 3 and the stator core 2A can be still more efficiently cooled while the advantageous effects of the first embodiment can be achieved. The outer peripheral portion 51 included in the insulating member 5 and contacting with the axial-direction flow passage ln27 is configured as the foam-layer-free portion 502 over the entire axial-direction area. Thereby, clogging of the axial-direction flow passages 27 by the peeled foam layer of the insulating member 5 can be suppressed. Further, narrowing of the axial-direction flow passages 27 due to the foam layers can be suppressed.

### Third Embodiment

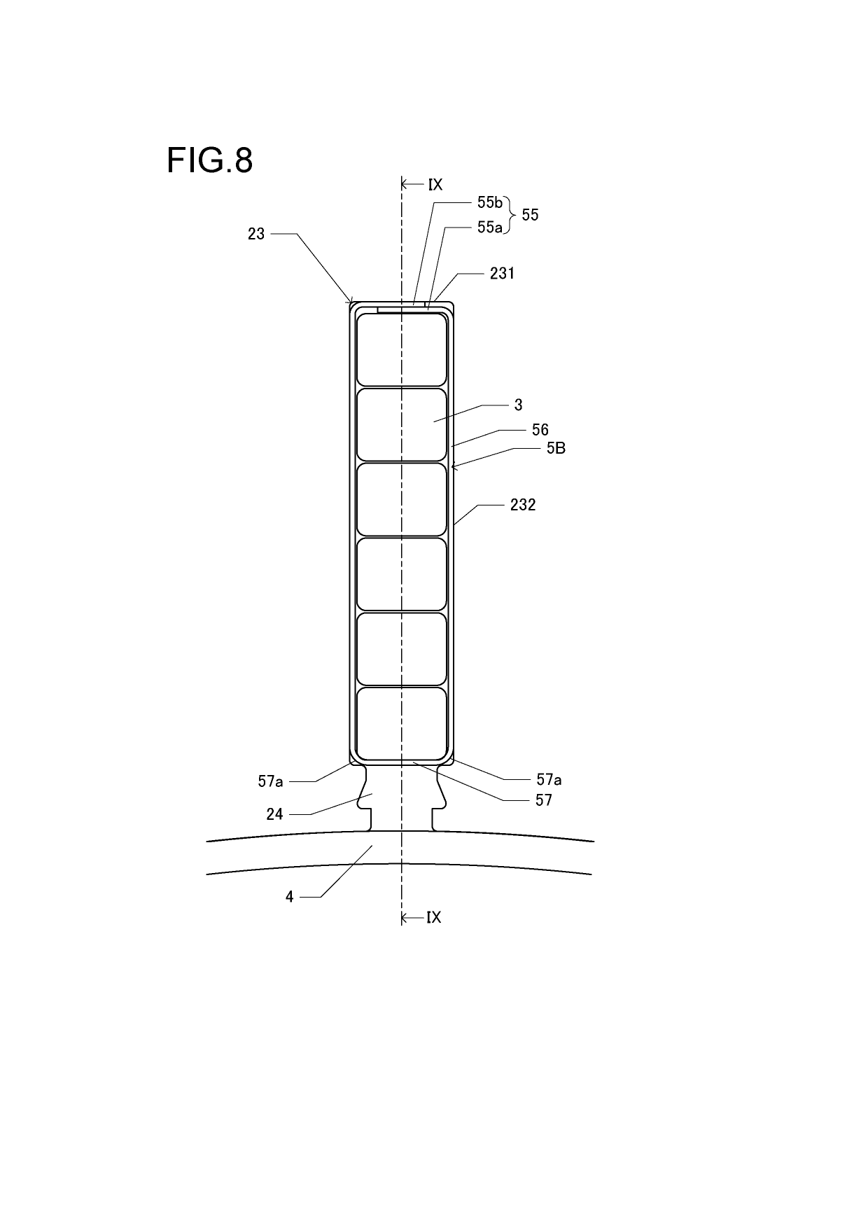

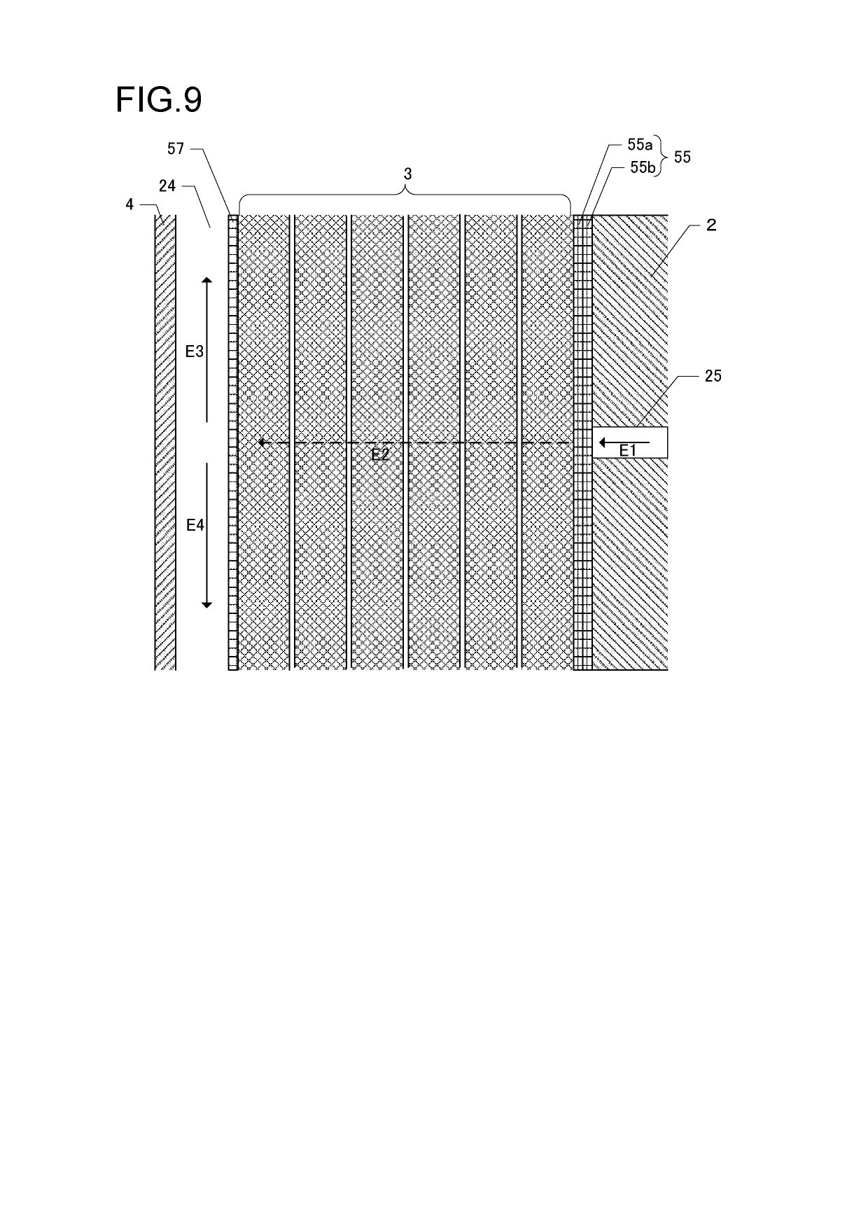

Next, a third embodiment of this disclosure is described mainly concerning matters different from those in the above-described respective embodiments. FIG. 8 illustrates the slot 23, an insulating member 5B, and the like in this embodiment viewed in the axial direction. FIG. 8 depicts a shape of the slot 23 at each position other than the axial-direction central position. FIG. 9 is a sectional view at the line IX-IX in FIG. 8. In FIG. 8 and FIG. 9, constituents equivalent to those in the above-described respective embodiments are denoted by the same reference signs. The description of these constituents is omitted as appropriate. In this embodiment, a shape of the insulating member 5B differs from that of the insulating member 5 of the first embodiment. The constituents other than the insulating member 5B, specifically, the stator core 2, the slot 23, the coils 3, and the inner circumferential cover 4, are the same as those in the first embodiment.

The insulating member 5B includes an outer peripheral portion 55, side portions 56, and an inner peripheral portion 57. The outer peripheral portion 55 is a portion located on a radial-direction outer side of the coils 3 and facing the bottom surface 231 of the slot 23. The outer peripheral portion 55 includes a first outer peripheral portion 55a and a second outer peripheral portion 55b. When viewed in the axial direction, the first outer peripheral portion 55a constitutes a portion included in one end portion of the insulating member 5B, and the second outer peripheral portion 55b constitutes a portion included in the other end portion of the insulating member 5B. A pair of the outer peripheral portions 55a and 55b are provided in such a way as to overlap with each other. In other words, at least a part of the first outer peripheral portion 55a is provided on a radial-direction inner side of the second outer peripheral portion 55b. A radial-direction outer surface of the first outer peripheral portion 55a contacts with a radial-direction inner surface of the second outer peripheral portion 55b. The outer peripheral portion 55 contacts with the radial-direction outer surface of the coil 3. Specifically, at least the first outer peripheral portion 55a contacts with the coil 3. The outer peripheral portion 55 contacts with the bottom surface 231. Specifically, at least the second outer peripheral portion 55b contacts with the bottom surface 231.

Portions included in the first outer peripheral portion 55a and the second outer peripheral portion 55b and excluding portions at the axial-direction central position are each configured as the double-sided foam portion 501 illustrated in FIG. 4A. The foam layer 5c provided on the inner surface of the base material 5a of the first outer peripheral portion 55a fills a gap between the base material 5a and the coil 3. The foam layer 5b provided on the outer surface of the base material 5a of the second outer peripheral portion 55b fills a gap between the base material 5a and the bottom surface 231. In this manner, the foam layers 5b and 5c cause the outer peripheral portion 55 to be closely contacted with and adhered to the bottom surface 231 and the coil 3 at each position other than the axial-direction central position. Portions included in the first outer peripheral portion 55a and the second outer peripheral portion 55b and located at the central position in the axial direction face the flow passage 25 (refer to FIG. 9) of the stator core 2, and are thus configured as the foam-layer-free portions 502.

The side portions 56 are equivalent to the side portions 52 in the first embodiment. The inner peripheral portion 57 is a portion located on a radial-direction inner side of the coils 3. When viewed in the axial direction, the inner peripheral portion 57 extends linearly in a direction perpendicular to the radial direction in such a way as to be along the radial-direction inner surface of the coil 3. The inner peripheral portion 57 contacts with the axial-direction flow passage 24. The inner peripheral portion 57 excluding the corner portions 57a is configured as the foam-layer-free portion 502 illustrated in FIG. 4B, over the entire area in the axial direction. The corner portions 57a of the inner peripheral portion 57 may be configured as the foam-layer-free portion 502 or as the double-sided foam portion 501.

In this manner, at each position other than the central position in the axial direction, the outer peripheral portion 55 and the side portions 56 are each configured as the double-sided foam portion 501 over the entire area along an outer periphery of the coils 3 when viewed in the axial direction, except for the corner portions 57a each located at a boundary between the side portion 56 and the inner peripheral portion 57. Except for portions of the coil 3 that contact with the corner portions 57a, the side surfaces and the radial-direction outer surface of the coils 3 are fixed to the wall surfaces 231 and 232 of the slot 23 facing the side surfaces and the radial-direction outer surface of the coils 3, by the foam layers 5b and 5c of the outer peripheral portion 55 and the side portions 56 over the entire area along the outer periphery of the coils 3, when viewed in the axial direction. Further, the outer peripheral portion 55 and the side portions 56 are each configured as the double-sided foam portion 501 over the entire area except for the central position in the axial direction.

FIG. 9 indicates the flows of the refrigerant by the arrows E1 to E4. The flows E1 to E4 are equivalent to the flows E1 to E4 (refer to FIGS. 3 and 5) in the first embodiment.

According to this embodiment, the advantageous effects similar to those in the first embodiment can be achieved. In other words, the inner peripheral portion 57 contacting with the axial-direction flow passage 24 is configured as the foam-layer-free portion 502 over the entire area in the axial direction, and thus, clogging of the axial-direction flow passage 24 due to the peeled foam layer of the insulating member 5 can be suppressed. Further, narrowing of the axial-direction flow passage 24 due to the foam layers can be suppressed. A portion included in the outer peripheral portion 55 and located at the central position in the axial direction is configured as the foam-layer-free portion 502. Thereby, clogging of the flow passage 25 or the flow passage in the slot central portion in the stator core 2 due to the foam layer of the insulating member 5 can be suppressed. Furthermore, the inner peripheral portion 57 is provided in such a way as to cover the radial-direction inner surface of the coil 3. Thereby, the coil 3 can be more effectively insulated from the stator core 2.

### Fourth Embodiment

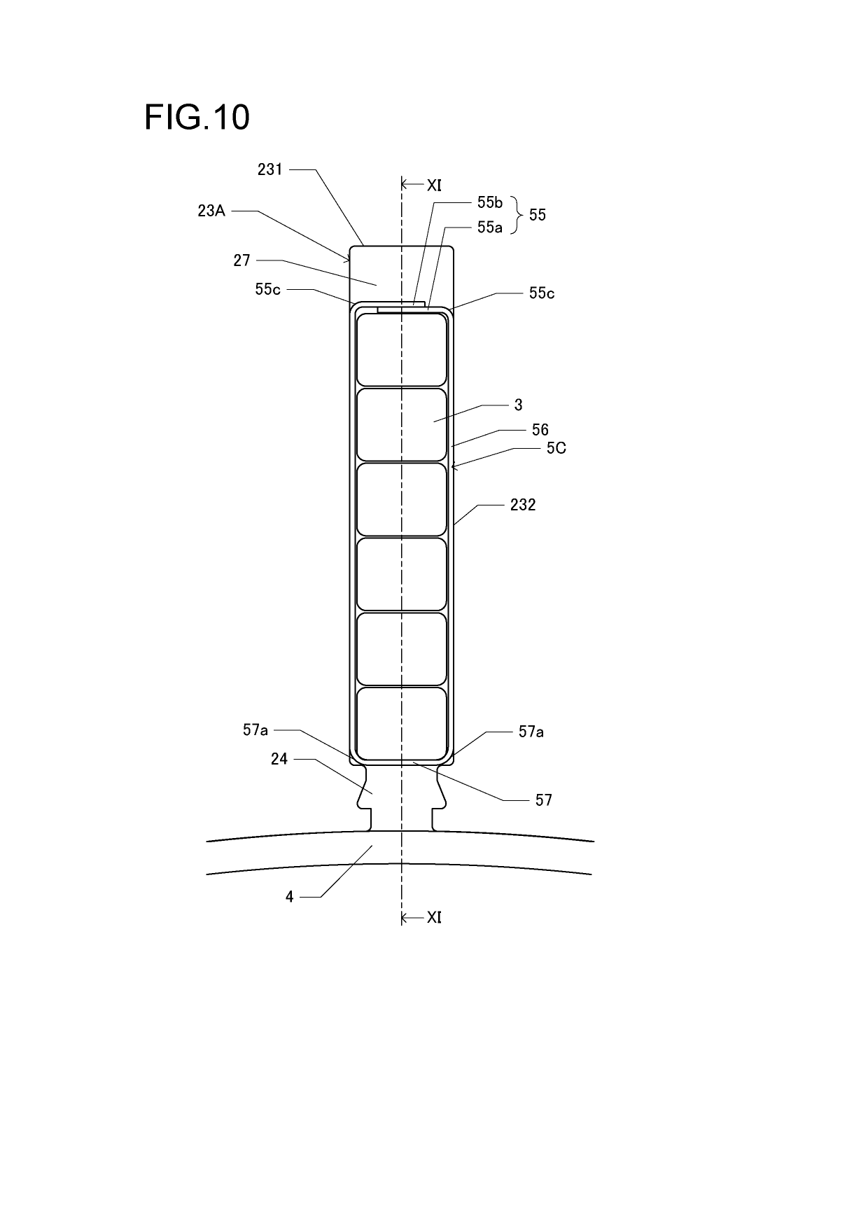

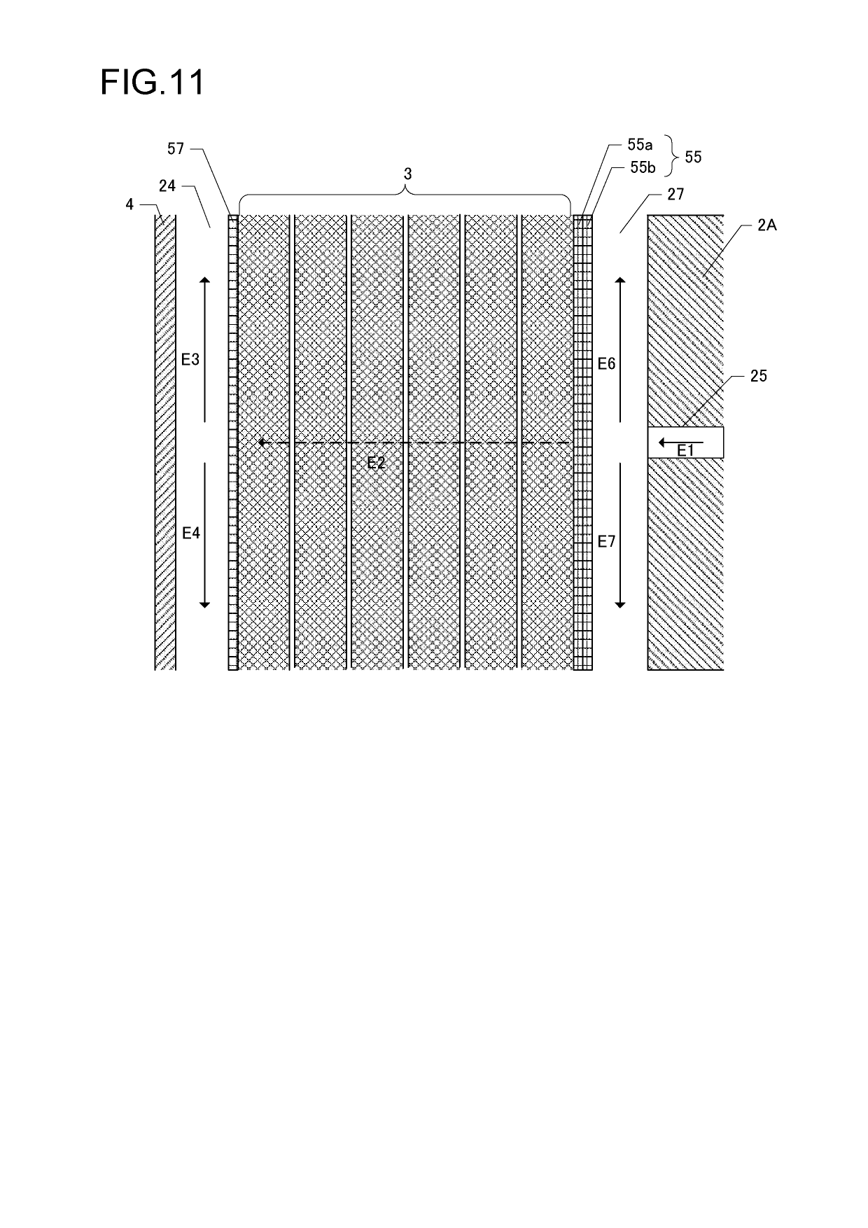

Next, a fourth embodiment of this disclosure is described mainly concerning matters different from those in the above-described respective embodiments. FIG. 10 illustrates the slot 23A, an insulating member 5C, and the like in this embodiment viewed in the axial direction. FIG. 10 depicts a shape of the slot 23A at each position other than the central position in the axial direction. FIG. 11 is a sectional view at the line XI-XI in FIG. 10. In FIGS. 10 and 11, constituents equivalent to those in the above-described respective embodiments are denoted by the same reference signs. The description of these constituents is omitted as appropriate. In this embodiment, the stator core 2A and the slot 23A are configured in such a way as to be equivalent to those in the second embodiment.

The outer peripheral portion 55 of the insulating member 5C is configured as the foam-layer-free portion 502 over the entire area in the axial direction. Corner portions 55c of the outer peripheral portion 55 may be each configured as the foam-layer-free portion 502 or as the double-sided foam portion 501. The side portions 56 excluding the corner portions 55c and 57a are each configured as the double-sided foam portion 501 over the entire area along the outer periphery of the coils 3 when viewed in the axial direction. Except for portions of the coils 3 that contact with the corner portions 55c and 57a, the side surfaces of the coils 3 are fixed to the wall surfaces 232 of the slots 23A facing the side surfaces of the coils 3, by the foam layers 5b and 5c of the side portions 56, over the entire area along the outer periphery of the coils 3, when viewed in the axial direction. Further, the side portions 56 are each configured as the double-sided foam portion 501 over the entire axial-direction area excluding the central position in the axial direction. The insulating member 5C is equivalent to the insulating member 5B of the third embodiment, except for the above-described matters.

The coils 3 and the inner circumferential cover 4 are equivalent to those in the above-described embodiments. The flows E1 to E6 of the refrigerant are equivalent to those (refer to FIG. 7) in the second embodiment. In this embodiment, the refrigerant flows in the axial-direction flow passage 27 in the axial direction, and the outer peripheral portion 55 is configured as the foam layer-free portion 502. Thereby, the advantageous effects similar to those in the second embodiment can be achieved.

### Fifth Embodiment

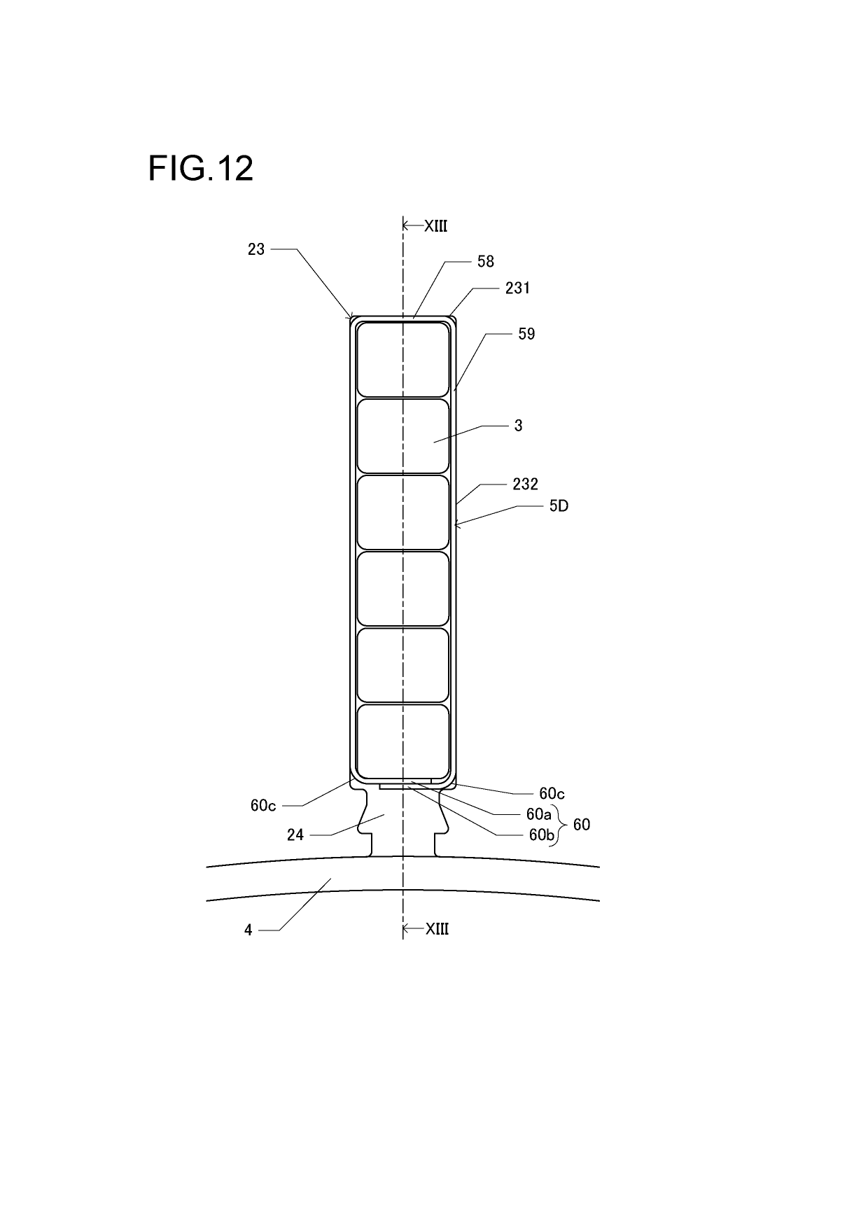

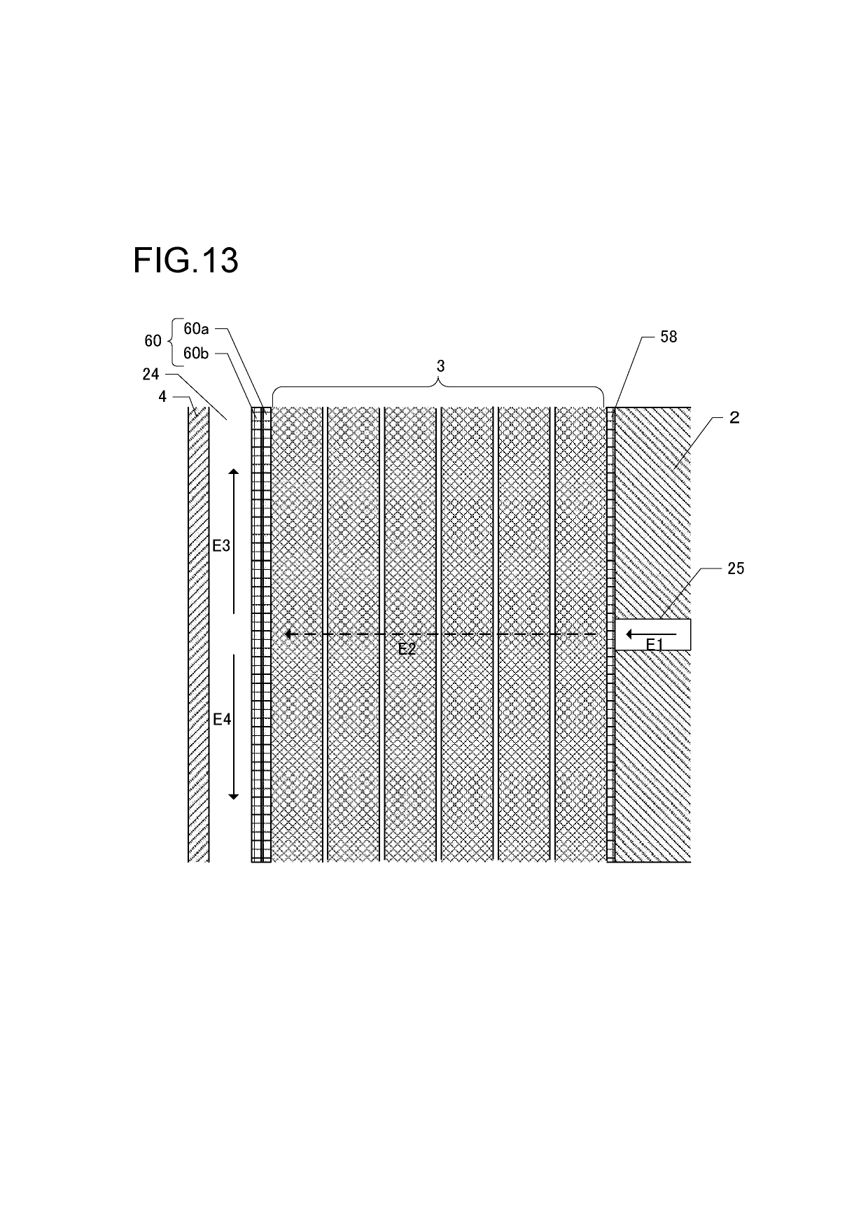

Next, a fifth embodiment of this disclosure is described mainly concerning matters different from those in the above-described respective embodiments. FIG. 12 illustrates the slot 23, an insulating member 5D, and the like in this embodiment viewed in the axial direction. FIG. 12 depicts a shape of the slot 23 at each position other than the central position in the axial direction. FIG. 13 is a sectional view at the line XIII-XIII in FIG. 12. In FIG. 12 and FIG. 13, constituents equivalent to those in the above-described respective embodiments are denoted by the same reference signs. The description of the constituents is omitted as appropriate. In this embodiment, a shape of the insulating member 5D differs from that of the insulating member 5 of the first embodiment. The constituents other than the insulating member 5D, specifically, the stator core 2, the slot 23, the coils 3, and the inner circumferential cover 4, are the same as those in the first embodiment.

The insulating member 5D includes an outer peripheral portion 58, side portions 59, and an inner peripheral portion 60. The outer peripheral portion 58 and the side portions 59 are equivalent to the outer peripheral portion 51 and the side portions 52 in the first embodiment. In other words, at each position other than the central position in the axial direction, the outer peripheral portion 58 and the side portions 59 are each configured as the double-sided foam portion 501 over the entire area along the outer periphery of the coils 3, when viewed in the axial direction, except for corner portions 60c each located at a boundary between the side portion 59 and the inner peripheral portion 60. Except for portions of the coil 3 that contact with the corner portions 60c, the side surfaces and the radial-direction outer surface of the coils 3 are fixed to the wall surfaces 231 and 232 of the slot 23 facing the side surfaces and the radial-direction outer surface of the coils 3, by the foam layers 5b and 5c of the outer peripheral portion 58 and the side portions 59, over the entire area along the outer periphery of the coils 3, when viewed in the axial direction. Further, the outer peripheral portion 58 and the side portions 59 are each configured as the double-sided foam portion 501 over the entire axial-direction area excluding the central position in the axial direction.

The inner peripheral portion 60 includes a first inner peripheral portion 60a and a second inner peripheral portion 60b. When viewed in the axial direction, the first inner peripheral portion 60a constitutes a portion included in one end portion of the insulating member 5D, and the second inner peripheral portion 60b constitutes a portion included in the other end of the insulating member 5D. A pair of the inner peripheral portions 60a and 60b are provided in such a way as to overlap with each other. In other words, at least a part of the first inner peripheral portion 60a is provided on a radial-direction outer side of the second inner peripheral portion 60b. A radial-direction inner surface of the first inner peripheral portion 60a contacts with a radial-direction outer surface of the second inner peripheral portion 60b. The radial-direction inner surface of the coil 3 is covered with the inner peripheral portion 60. The inner peripheral portion 60 contacts with the radial-direction inner surface of the coil 3. Specifically, at least the first inner peripheral portion 60a contacts with the coil 3. The inner peripheral portion 60 contacts with the axial-direction flow passage 24. The first inner peripheral portion 60a and the second inner peripheral portion 60b are each configured as the foam-layer-free portion 502 illustrated in FIG. 4B over the entire area in the axial direction. The corner portions 60c of the inner peripheral portion 60 may be each configured as the foam-layer-free portion 502 or as the double-sided foam portion 501.

The flows E1 to E4 of the refrigerant are equivalent to those (refer to FIG. 5) in the first embodiment. In this embodiment, the refrigerant flows in the axial-direction flow passage 24 in the axial direction, and the inner peripheral portion 60 is configured as the foam-layer-free portion 502. Thereby, the advantageous effects similar to those in the first embodiment can be achieved. Further, the inner peripheral portion 60 is provided in such a way as to cover the radial-direction inner surface of the coil 3. Thereby, the coil 3 can be more effectively insulated from the stator core 2.

### Sixth Embodiment

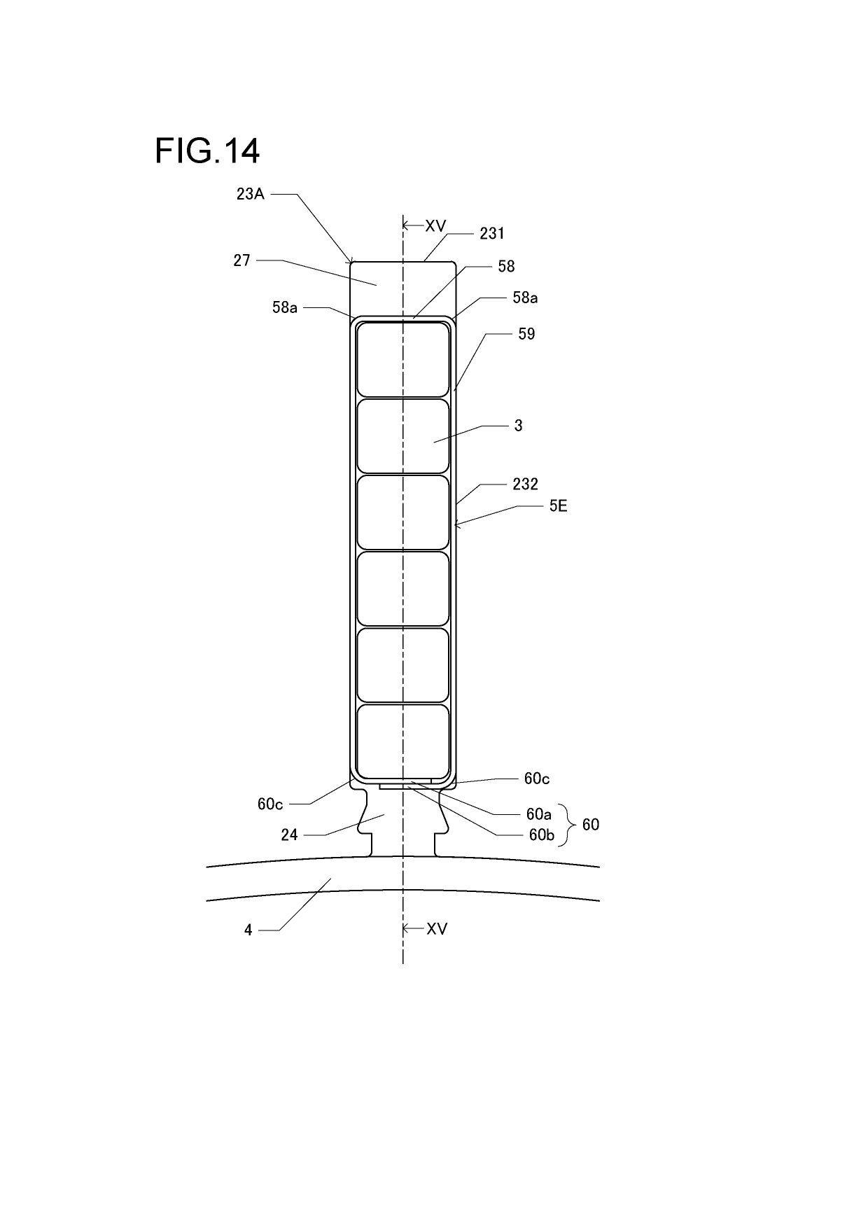

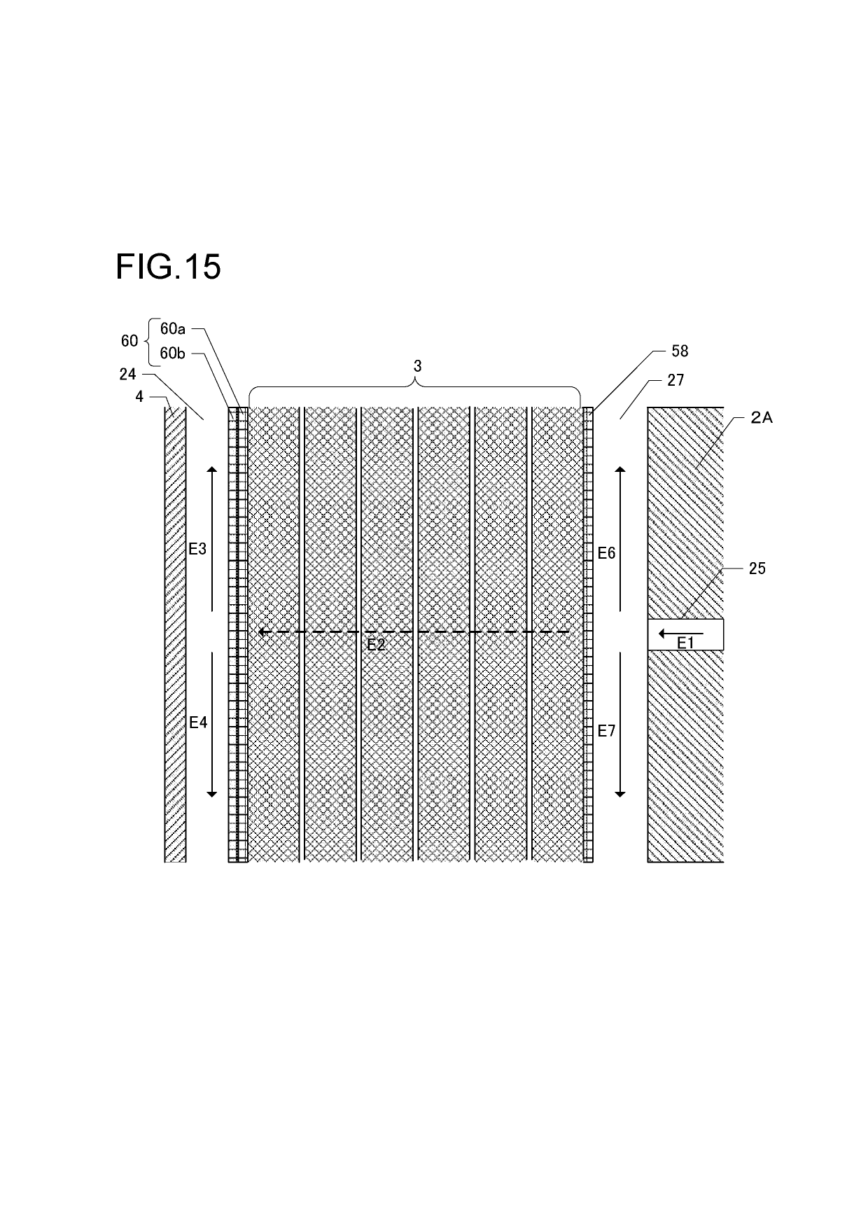

Next, a sixth embodiment of this disclosure is described mainly concerning matters different from those in the above-described respective embodiments. FIG. 14 illustrates the slot 23A, an insulating member 5E, and the like in this embodiment viewed in the axial direction. FIG. 14 depicts a shape of the slot 23A at each position other than the central position in the axial direction. FIG. 15 is a sectional view at the line XV-XV in FIG. 14. In FIGS. 14 and 15 , constituents equivalent to those in the above-described respective embodiments are denoted by the same reference signs. The description of these constituents is omitted as appropriate. In this embodiment, the stator core 2A and the slot 23A are configured in such a way as to be equivalent to those in the second embodiment. The insulating member 5E differs from the insulating member 5D of the fifth embodiment in including an outer peripheral portion 58 that is configured as the foam-layer-free portion 502 over the entire area in the axial direction (except for corner portions 58a). The corner portions 58a of the outer peripheral portion 58 may be each configured as the foam-layer-free portion 502 or as the double-sided foam portion 501.

Side portions 59 included in the insulating member 5E and excluding the corner portions 58a and 60c are each configured as the double-sided foam portion 501 over the entire area along the outer periphery of coils 3, when viewed in the axial direction. The side surfaces included in the coils 3 and excluding portions contacting with the corner portions 58a and 60c are fixed to the wall surfaces 232 of slot 23A facing the side surfaces of the coils 3, by the foam layers 5b and 5c of the side portions 59 over the entire area along the outer periphery of the coils 3, when viewed in the axial direction. Further, the side portions 59 are each configured as the double-sided foam portion 501 over the entire axial-direction area excluding the axial-direction center position. The other matters of the insulating member 5E are equivalent to those of the insulating member 5D. The coils 3 and the inner circumferential cover 4 are equivalent to those in the above-described embodiments. The flows E1 to E6 of the refrigerant are equivalent to those (refer to FIG. 7) in the second embodiment.

In this embodiment, the refrigerant flows in the axial-direction flow passages 24 and 27 in the axial direction. Thereby, the coils 3 and the stator core 2A can be still more efficiently cooled. The inner peripheral portion 60 and the outer peripheral portion 58 that contact with the axial-direction flow passages 24 and 27 are each configured as the foam-layer-free portion 502 over the entire area in the axial direction. Thereby, clogging of the axial-direction flow passages 24 and 27 due to the peeled foam layer of the insulating member 5E can be suppressed. Further, narrowing of the axial-direction flow passages 24 and 27 due to the foam layers can be suppressed. The inner peripheral portion 60 is provided in such a way as to cover the radial-direction inner surface of the coil 3. Thereby, the coil 3 can be more effectively insulated from the stator core 2.

### Other Embodiments

In the examples described in the above respective embodiments, the portion included in the insulating member and contacting with the axial-direction flow passage is configured as the foam-layer-free portion. However, this disclosure is not limited to this. No foam layer may be provided on at least the outer surface that is the surface of the base material in the insulating member and that is located on a side of the axial-direction flow passage, and the foam layer may be provided on the inner surface that is the surface of the base material in the insulating member and that is located on an opposite side of the outer surface of the base material. Specifically, the outer peripheral portion 51 in FIG. 6, the inner peripheral portion 57 in FIG. 8, the outer peripheral portion 55 in FIG. 10, the inner peripheral portion 57 in FIG. 10, the inner peripheral portion 60 in FIG. 12, the outer peripheral portion 58 in FIG. 14, and the inner peripheral portion 60 in FIG. 14 may be each configured as a single-sided foam portion 503. The single-sided foam portion 503 configured in such a way that no foam layer is provided on the outer surface of the base material 5a, and the foam layer 5c is provided on the inner surface of the base material 5a, as illustrated in FIG. 4C. The outer peripheral portion 51 in FIG. 6, the inner peripheral portion 57 in FIG. 8, the outer peripheral portion 55 in FIG. 10, the inner peripheral portion 57 in FIG. 10, the inner peripheral portion 60 in FIG. 12, the outer peripheral portion 58 in FIG. 14, and the inner peripheral portion 60 in FIG. 14 are each a portion that contacts with the axial-direction flow passage 27 or the axial-direction flow passage 24 and that covers the radial-direction outer surface or the radial-direction inner surface of the coil 3. The non-contact portions 54 in FIG. 2 and FIG. 6 may be each configured as the single-sided foam portion 503. Even when the portions 51, 54, 55, 57, 58, and 60 included in the insulating members 5 and 5A to 5E and contacting with the axial-direction flow passage 24 or 25 are configured as the single-sided foam portions 503, the flowing of the foam layer into the axial-direction flow passages 24 and 25 can be suppressed. In addition, the coil 3 can be more effectively fixed in the slots 23 and 23A.

In the above-described embodiments, in the slot center portion 230 illustrated in FIG. 3, the outer peripheral portion 51, the side portions 52, and the corner portions 53 as well as the non-contact portions 54 in the insulating member 5 are configured as the foam-layer-free portions 502. However, this disclosure is not limited to this. Each of the portions 51 to 53 illustrated in FIG. 3 only needs to be configured in such a way that no foam layer is provided on at least the outer surface that is included in each of the portions 51 to 53 and that is the surface on a side of the gap 26. In other words, each of the portions 51 to 53 illustrated in FIG. 3 may be configured as the single-sided foam portion 503 illustrated in FIG. 4C. The non-contact portions 54 in the slot central portion 230 may also be configured as the single-sided foam portions 503. Thereby, the flowing of the foam layers into the central flow passage 26 and the flow passage 25 of the stator core 2 can be suppressed, and the coils 3 can be more effectively fixed in the slot 23.

In the examples described in the above embodiments, the refrigerant is supplied to the axial-direction flow passage from the central position that is among intermediate positions between one axial-direction end portion and the other axial-direction end portion of the axial-direction passage and at which the axial-direction flow passage is divided into two equal positions in the axial direction. However, this disclosure is not limited to this. The refrigerant may be supplied to the axial-direction flow passage from the position other than the central position in the axial direction. Specifically, the refrigerant may be supplied to the one axial-direction end portion of the axial-direction flow passage, and may flow out from the other axial-direction end portion. Alternatively, the refrigerant may be supplied to the axial-direction flow passage from a position that is among the above-described intermediate positions and at which the axial-direction flow passage is not divided into two equal positions in the axial direction, and may flow out from both end portions of the axial-direction flow passage.

In the examples described in the above embodiments, the non-contact portions of the insulating member that do not contact with the coil contact with the axial-direction flow passage that penetrates through the stator core in the axial direction. However, this disclosure is not limited to this. The non-contact portions may contact with a flow passage other than the axial-direction flow passage that penetrates through the stator core in the axial direction. Even in this case, the non-contact portions may be each configured as one of the foam-layer-free portion and the one-sided foam portion in each of which no foam layer is provided on at least the surface facing the flow passage. In other words, the stator according to this disclosure may be configured as follows.
A stator including:
an annular stator core that includes a plurality of teeth arranged in a circumferential direction and protruding in a radial direction, and a plurality of slots each formed between the teeth in the circumferential direction;
a coil arranged in the slot; and
an insulating member that is provided in the slot in such a way as to surround the coil, and includes a sheet-shaped base material, wherein
a flow passage for a refrigerant is formed in the slot,
at least a portion that is included in the insulating member and that does not contact with the flow passage is configured as a double-sided foam portion in which foam layers are provided on both surfaces of the base material, and the foam layers fill a gap between one of these surfaces and the coil and a gap between the other of these surfaces and a wall surface of the slot;
when viewed in an axial direction, a portion included in one end portion of the insulating member and
a portion included in the other end portion of the insulating member do not contact with the coil, and a portion that is included in the insulating member and that does not contact with the coil contacts with the flow passage, and includes both surfaces on each of which the foam layer is not provided.

According to this configuration, at least a part in the portion that is included in the insulating member and that does not contact with the flow passage is configured as the double-sided foam portion in which the foam layers are provided on both surfaces of the base material of the insulating member. Thereby, a possibility that the coil can be effectively fixed in the slot can be increased as compared to a configuration in which the foam layer is provided on only the one-side surface of the base material. The double-sided foam portion is provided at the portion that does not contact with the flow passage. Thereby, a possibility of suppressing the peeling of the foam layer of the double-sided foam portion due to the refrigerant can be increased. Further, when viewed in the axial direction, the insulating member includes a pair of the non-contact portions as portions that do not contact with the coil and one of which is included in the one end portion of the insulating member and the other of which is included in the other end portion of the insulating member. A pair of the non-contact portions contact with the flow passage in the slot, but the foam layer is not provided on either surface of each of the non-contact portions. Thereby, a possibility of suppressing the peeling of the foam layer from the insulating member can be increased.

In the examples described in the above embodiments, at each position that is among positions along the axial direction and at which any refrigerant flow passage other than the axial-direction flow passage does not exist in the slot, the portions included in the insulating member that do not contact with the axial-direction flow passage is configured as the double-sided foam portions over the entire area along the outer periphery of the coils, when viewed in the axial direction, except for the corner portions of the insulating member each located at the boundary between the portion included in the insulating member and contacting with the axial-direction flow passage and the portion that is included in the insulating member and that does not contact with the axial-direction flow passage. However, this disclosure is not limited to this. When viewed in the axial direction, the portions included in the insulating member that do not contact with the axial-direction flow passage may be each configured as the double-sided foam portion in a partial section along the outer periphery of the coils, and as the foam-layer-free portion or the single-sided foam portion in the remaining section along the outer periphery of the coils. In the foam-layer-free portion, no foam layers are provided on both surfaces of the base material. In the single-sided foam portion, the foam layer is provided on only the one-side surface (the outer surface or the inner surface) of the base material. For example, when viewed in the axial direction, the outer peripheral portion 51 and the side portions 52 in FIG. 2 may be each configured as the double-sided foamed portion 501 in the partial section along the outer periphery of the coils, and as the foam-layer-free portion 502 or the single-sided foam portion 503 in the remaining section along the outer periphery of the coils.

In the examples described in the above embodiments, the portions included in the insulating member that do not contact with the axial-direction flow passage are each configured as the double-sided foam portion over the entire axial-direction area excluding the central position that is the axial-direction position at which the flow passage for the refrigerant other than the axial-direction flow passage is provided. However, this disclosure is not limited to this. The portions included in the insulating member that do not contact with the axial-direction flow passage may be configured as the double-sided foam portion in a partial section in the axial direction excluding the axial-direction central position, and as the foam-layer-free portion or the single-sided foamed portion in the remaining section in the axial direction. In the foam-layer-free portion, no foam layers are provided on both surfaces of the base material. In the single-sided foam portion, the foam layer is provided on only the one-side surface (the outer surface or the inner surface) of the base material. For example, the outer peripheral portion 51 and the side portions 52 in FIG. 2 may be each configured as the double-sided foam portion 501 in a partial section in the axial direction excluding the central position, and as the foam-layer-free portion 502 or the single-sided foam portion 503 in the remaining section in the axial direction.

Instead of the inner circumferential cover 4, a member that closes the radial-direction inner opening of the slot 23 or 23A may be provided for each slot 23 or 23A. The axial-direction flow passage may be provided at a position other than a position on a radial-direction inner or outer side of the coils, i.e., at a position adjacent to the coil and the insulating member in the circumferential direction of the stator core. In this case, no foam layer may be provided, over the entire axial-direction area of the base material of the insulating member, on at least the axial-direction-flow-passage-side surface of the base material in a part that is included in the side portion of the insulating member and that contacts with the axial-direction flow passage.

The stator core may be an annular member including a plurality of the teeth arranged in the circumferential direction and a plurality of the slots each formed between the teeth in the circumferential direction. In other words, the stator core may be configured in such a way that a plurality of the slots are formed by the teeth, and each of the slots receives the coil. In this case, the stator core may be configured in such a way that the rotor can rotate relative to the stator by the interaction between the magnetic field generated by the coils and the magnetic field generated by the rotor. The stator core may have any of various configurations each specified by the number of the magnetic poles, the number of the slots, and a material of the stator core.

The stator core may be annular as a whole. Shapes of a radial-direction inner surface and a radial-direction outer surface of a ring formed by the stator core are not particularly limited. For example, when viewed in the axial direction, the radial-direction outer surface may be circular or have a shape such as a polygon. The teeth are formed on the radial-direction inner surface, and the slots are each formed between the teeth. A general shape of the stator core including the teeth can be regarded as annular, and a part formed by the stator core excluding the teeth can be regarded as annular. The stator according to this disclosure may also be applied to a generator that is one type of rotating electrical machine.

The coils may be arranged in the slots. A shape of each of the coils and a method for arranging the coils are not particularly limited. Accordingly, the coils may be wound around the teeth, or segment coils may be inserted in the axial direction and joined to each other at the axial-direction end portions. The coils each include at least the accommodated portions that are accommodated in the slots and the coil end portions that protrude in the axial direction from the end surfaces of the stator core. The accommodated portion is a portion accommodated in the slot, and is typically a portion that is in the slot and that is sandwiched between the two end surfaces of the stator core in the axial direction. The coil end portion is a portion protruding in the axial direction from the end surface of the stator core. In other words, the coil end portion is a portion existing on an opposite side of the slot with respect to the end surface of the stator core.

A stator according to one embodiment includes an annular stator core, a coil, and an insulating member. The stator core includes a plurality of teeth being arranged in a circumferential direction and protruding in a radial direction, and a plurality of slots each formed between the teeth in the circumferential direction. The coil is arranged in the slot. The insulating member is provided in the slot in such a way as to surround the coil, and includes a sheet-shaped base material. An axial-direction flow passage for a refrigerant is formed in the slot in such a way as to penetrate between both ends of the slot in an axial direction of the stator core. At least a part in a portion that is included in the insulating member and that does not contact with the axial-direction flow passage is configured as a double-sided foam portion in which foam layers are provided on both surfaces of the base material. The foam layers fill a gap between one of the surfaces and the coil and a gap between another of the surfaces and a wall surface of the slot. In a portion being included in the insulating member and contacting with the axial-direction flow passage, the foam layer is absent over an entire area of the base material in the axial direction, on at least a surface of the base material on a side of the axial-direction flow passage.

According to this configuration, in a portion included in the insulating member and contacting with the axial-direction flow passage, the foam layer is absent over an entire area of the base material in the axial direction, at least on a surface of the base material on a side of the axial-direction flow passage. Thus, a possibility of suppressing peeling of the foam layer from the insulating member can be enhanced.

In the stator, the axial-direction flow passage may be provided on a radial-direction inner side or a radial-direction outer side of the coil, and a portion that is included in the insulating member and at which the foam layer is not provided may be a portion on a radial-direction inner side or a radial-direction outer side of the coil, on which side the axial-direction flow passage is located.

In the stator, when a bent portion included in the insulating member and located at a boundary in the insulating member between a portion contacting with the axial-direction flow passage and a portion that does not contact with the axial-direction flow passage is defined as a corner portion, a portion that is included in the insulating member and does not contact with the axial-direction flow passage may be configured as the double-sided foamed portion over an entire area along an outer periphery of the coil excluding the corner portion, when viewed from the axial direction.

In the stator, when viewed in the axial direction, a part included in one end portion of the insulating member and a part included in another end portion of the insulating member may not contact with the coil, and a portion that is included in the insulating member and does not contact with the coil may contact with the axial-direction flow passage, and include both surfaces on each of which the foam layer is not provided.

In the stator, in the stator core, a flow passage for supplying a refrigerant may be formed at an intermediate position in the slot in the axial direction, in a portion at the intermediate position in the slot, a gap serving as the flow passage for the refrigerant may be formed between a wall surface of the slot and the insulating member, and the gap may be connected to the axial-direction flow passage, and a portion being included in the insulating member, being located at the intermediate position, and contacting with the gap may be configured without the foam layer on at least a surface on a side of the gap.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A stator comprising:
an annular stator core that includes a plurality of teeth being arranged in a circumferential direction and protruding in a radial direction, and a plurality of slots each formed between the teeth in the circumferential direction;
a coil arranged in the slot; and
an insulating member that is provided in the slot in such a way as to surround the coil, and includes a sheet-shaped base material, wherein
an axial-direction flow passage for a refrigerant is formed in the slot in such a way as to penetrate between both ends of the slot in an axial direction of the stator core,
at least a part in a portion that is included in the insulating member and does not contact with the axial-direction flow passage is configured as a double-sided foam portion in which foam layers are provided on both surfaces of the base material, and the foam layers fill a gap between the surface and the coil and a gap between the surface and a wall surface of the slot, and,
in a portion included in the insulating member and located in the axial-direction flow passage, the base material is exposed over an entire area of the base material in the axial direction, on at least a surface of the base material on a side of the axial-direction flow passage.

2. The stator according to claim 1, wherein
the axial-direction flow passage is provided on a radial-direction inner side or a radial-direction outer side of the coil, and
a portion that is included in the insulating member and at which the foam layer is not provided is a portion on a radial-direction inner side or a radial-direction outer side of the coil, on which side the axial-direction flow passage is located.

3. The stator according to claim 1, wherein,
when a bent portion included in the insulating member and located at a boundary in the insulating member between a portion contacting with the axial-direction flow passage and a portion that does not contact with the axial-direction flow passage is defined as a corner portion,
a portion that is included in the insulating member and does not contact with the axial-direction flow passage is configured as the double-sided foamed portion over an entire area along an outer periphery of the coil excluding the corner portion, when viewed from the axial direction.

4. The stator according to claim 1, wherein,
when viewed in the axial direction, a part included in one end portion of the insulating member and a part included in another end portion of the insulating member do not contact with the coil, and
a portion that is included in the insulating member and does not contact with the coil contacts with the axial-direction flow passage, and includes both surfaces on each of which the foam layer is not provided.

5. The stator according to claim 1, wherein,
in the stator core, a flow passage for supplying a refrigerant is formed at an intermediate position in the slot in the axial direction,
in a portion at the intermediate position in the slot, a gap serving as the flow passage for the refrigerant is formed between a wall surface of the slot and the insulating member, and the gap is connected to the axial-direction flow passage, and
a portion being included in the insulating member, being located at the intermediate position, and contacting with the gap is configured without the foam layer on at least a surface on a side of the gap.
